(19) United States
(12) Patent Application Publication
(10) Pub. No.: US 2025/0178129 A1
(43) Pub. Date: Jun. 5, 2025

(54) ADDITIVELY MANUFACTURED OBJECTS WITH ACCESSIBLE SUPPORTS AND ASSOCIATED METHODS

(71) Applicant: Align Technology, Inc., San Jose, CA (US)

(72) Inventors: Peter Dorfinger, Woodside, CA (US); Sudharshan Anandan, Sunnyvale, CA (US); Yueping Wang, San Jose, CA (US); Chang Xu, Milpitas, CA (US); Peter Webber, San Francisco, CA (US); Joanne L. Lee, San Jose, CA (US); Michael Christopher Cole, San Jose, CA (US)

(21) Appl. No.: 18/967,281

(22) Filed: Dec. 3, 2024

Related U.S. Application Data
(60) Provisional application No. 63/606,036, filed on Dec. 4, 2023.

(51) Int. Cl. B23K 26/38; B22F 10/64; B33Y 40/20; B33Y 80/00

(52) U.S. Cl. CPC B23K 26/38; B22F 10/64; B33Y 40/20; B33Y 80/00

(57) ABSTRACT

Additively manufactured objects with exposed supports and associated methods are provided. In some embodiments, a method includes receiving one or more additively manufactured objects that are coupled to a plurality of support structures, where each support structure includes an exposed shoulder region that is accessible to an energy beam of a trimming system. The method can include identifying the locations of the exposed shoulder regions of the plurality of support structures, and directing the energy beam of the trimming system to the locations of the exposed shoulder regions of the plurality of support structures to cut at least partially through the exposed shoulder regions of the plurality of support structures.

### CROSS-REFERENCE TO RELATED APPLICATION(S)

The present application claims the benefit of priority to U.S. Provisional Application No. 63/606,036, filed Dec. 4, 2023, which is incorporated by reference herein in its entirety.

### TECHNICAL FIELD

The present technology generally relates to manufacturing, and in particular, to additively manufactured objects with accessible supports and associated methods.

### BACKGROUND

Additive manufacturing encompasses a variety of technologies that involve building up 3D objects from multiple layers of material. In some instances, support structures are added to the object during the additive manufacturing process to secure the object to the build platform, support unstable features, improve printing accuracy, or avoid stress-induced deformation. Typically, the support structures are broken off or otherwise manually removed from the object after fabrication, which can be time-consuming, inefficient for large scale manufacturing, presents a risk of damaging the object, and may leave unaesthetic blemishes on the object. Moreover, conventional support structure configurations may not be compatible with automated trimming systems, particularly when high throughput processing of multiple objects is needed.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram providing a general overview of a method for fabricating and post-processing an additively manufactured object, in accordance with embodiments of the present technology.

FIG. 2 is a partially schematic diagram providing a general overview of an additive manufacturing process, in accordance with embodiments of the present technology.

FIG. 3 is a partially schematic illustration showing shadowing issues that may arise when trimming support structures from additively manufactured objects.

FIG. 4A illustrates a system for trimming a plurality of additively manufactured objects with support structures, in accordance with embodiments of the present technology.

FIG. 4B is a closeup side view of a portion of an object of FIG. 4A with an individual support structure, in accordance with embodiments of the present technology.

FIG. 5 is a perspective view of an additively manufactured dental appliance including a plurality of support structures, in accordance with embodiments of the present technology.

FIG. 6A is a partially schematic side view of an additively manufactured object with a support structure, in accordance with embodiments of the present technology.

FIG. 6B is a partially schematic side view of an additively manufactured object with a support structure, in accordance with embodiments of the present technology.

FIG. 6C is a partially schematic side view of an additively manufactured object with a support structure, in accordance with embodiments of the present technology.

FIG. 6D is a partially schematic side view of an additively manufactured object with a support structure, in accordance with embodiments of the present technology.

FIG. 6E is a partially schematic side view of an additively manufactured object with a support structure, in accordance with embodiments of the present technology.

FIG. 6F is a partially schematic side view of an additively manufactured object with a support structure, in accordance with embodiments of the present technology.

FIG. 6G is a partially schematic side view of an additively manufactured object with a support structure, in accordance with embodiments of the present technology.

FIG. 6H is a partially schematic side view of an additively manufactured object with a support structure, in accordance with embodiments of the present technology.

FIG. 7A is a perspective view of an additively manufactured object with an internal support structure, in accordance with embodiments of the present technology.

FIG. 7B illustrates trimming of the internal support structure of FIG. 7A with an energy beam, in accordance with embodiments of the present technology.

FIG. 7C illustrates the object and internal support structure of FIG. 7A after trimming, in accordance with embodiments of the present technology.

FIG. 8A is a partially schematic side view of two additively manufactured objects with an interconnected support structure, in accordance with embodiments of the present technology.

FIG. 8B is a partially schematic side view of two additively manufactured objects with an interconnected support structure, in accordance with embodiments of the present technology.

FIG. 8C is a partially schematic side view of two additively manufactured objects with an interconnected support structure, in accordance with embodiments of the present technology.

FIG. 9 is a flow diagram illustrating a method for generating support structures for additively manufactured objects, in accordance with embodiments of the present technology.

FIG. 10 is a flow diagram illustrating a method for generating support structures for additively manufactured objects, in accordance with embodiments of the present technology.

FIG. 11 is a flow diagram illustrating a method for trimming support structures from additively manufactured objects, in accordance with embodiments of the present technology.

FIG. 12 is a flow diagram illustrating a method for trimming support structures from additively manufactured objects, in accordance with embodiments of the present technology.

FIG. 13 is a partially schematic illustration of a system for trimming support structures from additively manufactured objects, in accordance with embodiments of the present technology.

FIG. 14A illustrates a representative example of a tooth repositioning appliance configured in accordance with embodiments of the present technology.

FIG. 14B illustrates a tooth repositioning system including a plurality of appliances, in accordance with embodiments of the present technology.

FIG. 14C illustrates a method of orthodontic treatment using a plurality of appliances, in accordance with embodiments of the present technology.

FIG. 15 illustrates a method for designing an orthodontic appliance, in accordance with embodiments of the present technology.

FIG. 16 illustrates a method for digitally planning an orthodontic treatment and/or design or fabrication of an appliance, in accordance with embodiments of the present technology.

### DETAILED DESCRIPTION

The present technology relates to processing of additively manufactured objects, such as additively manufactured dental appliances. In some embodiments, for example, a method includes receiving one or more additively manufactured objects that are coupled to a plurality of support structures, where each support structure includes an exposed region that is accessible to an energy beam of a trimming system (e.g., a laser trimming system). For instance, the exposed region can be a shoulder of the support structure that extends laterally away from the object, is curved and/or angled away from the object, or otherwise lies outside of the footprint of the object, such that the energy beam can access the exposed region without passing through any of the additively manufactured objects. The method can also include identifying the locations of the exposed regions of the plurality of support structures, and directing the energy beam of the trimming system to the locations of the exposed regions of the plurality of support structures to cut at least partially through the exposed regions of the plurality of support structures.

The present technology can provide many advantages compared to conventional approaches for designing support structures for additively manufactured objects and/or to conventional approaches for removing support structures from additively manufactured objects after fabrication. For example, the support structures disclosed herein can be specifically designed to be compatible with laser trimming systems and/or other types of trimming systems that use energy to cut through material, thereby allowing for automated processing of multiple objects with customized geometries in a high throughput, time-efficient manner suitable for industrial scale manufacturing. Moreover, the techniques herein can be used to tightly pack multiple objects on a single build platform while still maintaining accessibility of the support structures to the trimming system, which can further improve scalability of the manufacturing process.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Methods for Trimming Additively Manufactured Objects and Associated Systems

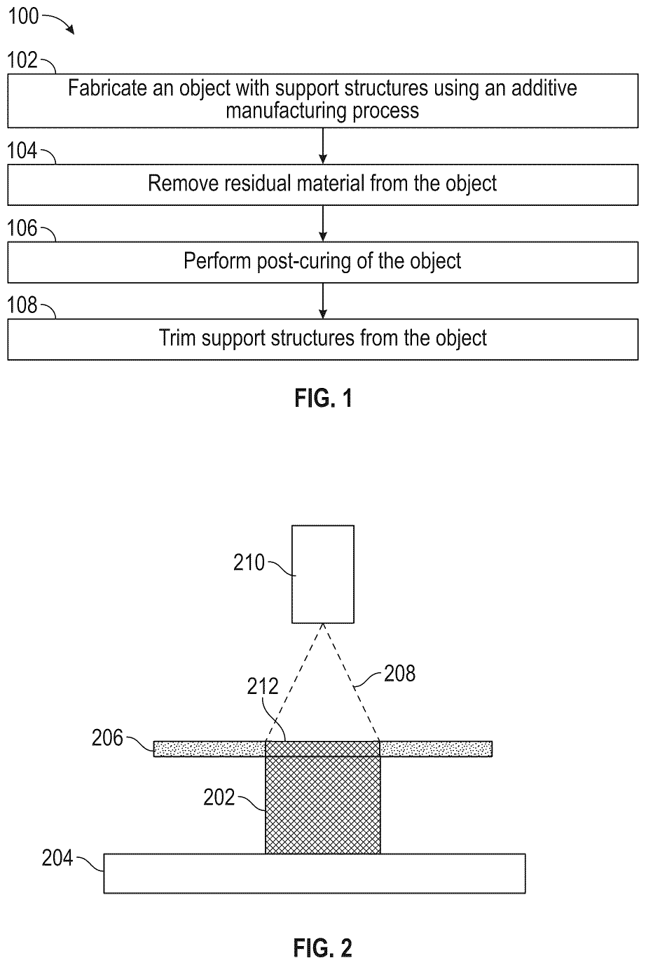

FIG. 1 is a flow diagram providing a general overview of a method 100 for fabricating and post-processing an additively manufactured object, in accordance with embodiments of the present technology. The method 100 can be used to produce many different types of additively manufactured objects, such as orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section II below.

The method 100 begins at block 102 with fabricating an object on a build platform using an additive manufacturing process. The additive manufacturing process can implement any suitable technique known to those of skill in the art. Additive manufacturing (also referred to herein as “3D printing”) includes a variety of technologies which fabricate 3D objects directly from digital models through an additive process. In some embodiments, additive manufacturing includes depositing a precursor material onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,624 and U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Pat. No. 10,162,264 and U.S. Patent Publication No. 2014/0265034, the disclosures of which are incorporated herein by reference in their entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

After the additively manufactured object is fabricated, the object can undergo one or more additional process steps, also referred to herein as “post-processing.” As described in detail below with respect to blocks 104-108, post-processing can include removing residual material from the object, performing post-curing of the object, and/or trimming support structures from the object.

For example, at block 104, the method 100 can continue with removing residual material from the object. The excess material can include excess precursor material (e.g., uncured resin) and/or other unwanted material (e.g., debris) that remains on or within the object after the additive manufacturing process. The residual material can be removed in many different ways, such as by exposing the object to a solvent (e.g., via spraying, immersion), heating or cooling the object, applying a vacuum to the object, blowing a pressurized gas onto the object, applying mechanical forces to the object (e.g., vibration, agitation, centrifugation, tumbling, brushing), and/or other suitable techniques. Optionally, the residual material can be collected and/or processed for reuse.

At block 106, the method 100 can optionally include post-curing the object. Post-curing is an additional curing process that can be used in situations where the object is still in a partially cured “green” state after fabrication. For example, the energy used to fabricate the object in block 102 may only partially polymerize the precursor material forming the object. Accordingly, the post-curing step may be needed to fully cure (e.g., fully polymerize) the object to its final, usable state. Post-curing can provide various benefits, such as improving the mechanical properties (e.g., stiffness, strength) and/or temperature stability of the object. Post-curing can be performed by heating the object, applying radiation (e.g., UV, visible, microwave) to the object, or suitable combinations thereof. In other embodiments, however, the post-curing process of block 106 is optional and can be omitted.

At block 108, the method 100 can include trimming support structures from the object. In some embodiments, the object includes support structures (e.g., struts, cones, rods, pins, arms, bridges, crossbars, blocks) that connect the object to the build platform. The support structures can provide mechanical support for one or more portions of the object, such as overhangs, bridges, islands, valleys, and/or other components that would deform or collapse without such support. Support structures can also be used to reinforce the object to reduce the likelihood of bending, warping, or other undesirable changes to the object geometry during post-processing (e.g., due to forces applied during centrifugation, exposure to solvents, changes in temperature, etc.). The support structures are typically not intended to be part of the final product, and thus may need to be removed from the rest of the object during post-processing.

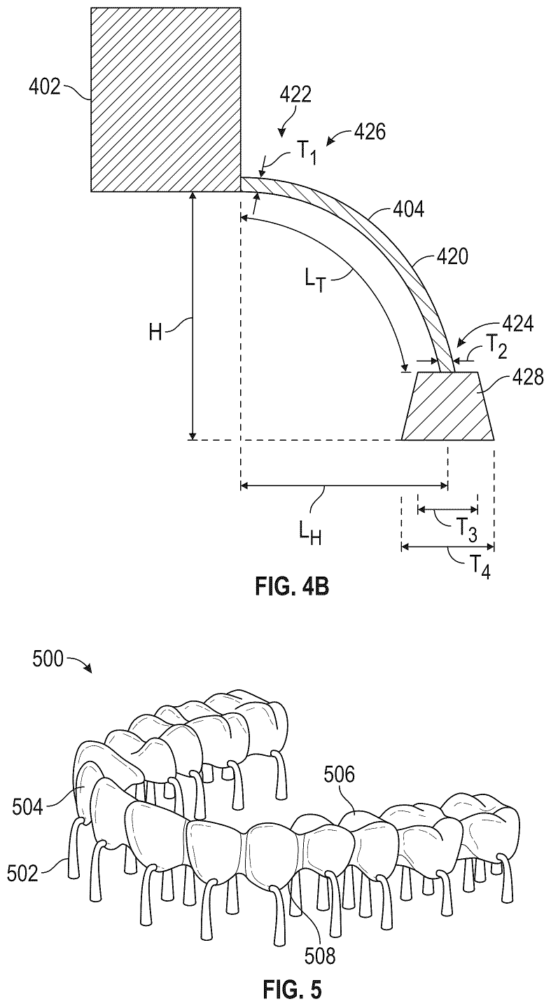

The process of removing support structures from the object (also referred to herein as “trimming” support structures from the object) can be performed using various techniques, such as mechanical forces (e.g., scraping, cutting, breaking), energy (e.g., cutting via a laser), exposure to conditions that weaken and/or degrade the support structures (e.g., solvents, high or low temperatures), or suitable combinations thereof. In some embodiments, the trimming is performed using an automated trimming system that requires little or no manual intervention to remove the support structures from an object. In such embodiments, the support structure can be specifically designed to be compatible with the automated trimming system, e.g., the geometry of the support structures can be configured to be accessible to the trimming system. Additional details and examples of methods and associated devices and systems for trimming support structures are described further below, e.g., in connection with FIGS. 4A-13.

The method 100 illustrated in FIG. 1 can be modified in many different ways. For example, although the above steps of the method 100 are described with respect to a single object, the method 100 can be used to sequentially or concurrently fabricate and post-process any suitable number of objects, such as tens, hundreds, or thousands of additively manufactured objects. As another example, the ordering of the processes shown in FIG. 1 can be varied (e.g., the process of block 108 can be performed before and/or concurrently with the processes of blocks 104 and/or 106). Some of the processes of the method 100 can be omitted, such as the process of block 106. Additionally, the method 100 can include processes not shown in FIG. 1, such as cleaning the object (e.g., washing, solvent extraction), annealing the object, separating the object from a build platform, performing surface modifications and/or treatments, and/or packaging the object for shipment.

FIG. 2 is a partially schematic diagram providing a general overview of an additive manufacturing process, in accordance with embodiments of the present technology. Additive manufacturing (also referred to herein as “3D printing”) includes a variety of technologies which fabricate 3D objects directly from digital models through an additive process. For example, additive manufacturing can be used to directly fabricate orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section II below.

In some embodiments, additive manufacturing includes depositing a precursor material (e.g., a polymeric resin) onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

For example, in the embodiment of FIG. 2, an object 202 is fabricated on a build platform 204 from a series of cured material layers, with each layer having a geometry corresponding to a respective cross-section of the object 202. To fabricate an individual object layer, a layer of curable material 206 (e.g., polymerizable resin) is brought into contact with the build platform 204 (when fabricating the first layer of the object 202) or with the previously formed portion of the object 202 on the build platform 204 (when fabricating subsequent layers of the object 202). In some embodiments, the curable material 206 is formed on and supported by a substrate (not shown), such as a film. Energy 208 (e.g., light) from an energy source 210 (e.g., a laser, projector, or light engine) is then applied to the curable material 206 to form a cured material layer 212 on the build platform 204 or on the object 202. The remaining curable material 206 can then be moved away from the build platform 204 (e.g., by lowering the build platform 204, by moving the build platform 204 laterally, by raising the curable material 206, and/or by moving the curable material 206 laterally), thus leaving the cured material layer 212 in place on the build platform 204 and/or object 202. The fabrication process can then be repeated with a fresh layer of curable material 206 to build up the next layer of the object 202.

The illustrated embodiment shows a “top down” configuration in which the energy source 210 is positioned above and directs the energy 208 down toward the build platform 204, such that the object 202 is formed on the upper surface of the build platform 204. Accordingly, the build platform 204 can be incrementally lowered relative to the energy source 210 as successive layers of the object 202 are formed. In other embodiments, however, the additive manufacturing process of FIG. 2 can be performed using a “bottom up” configuration in which the energy source 210 is positioned below and directs the energy 208 up toward the build platform 204, such that the object 202 is formed on the lower surface of the build platform 204. Accordingly, the build platform 204 can be incrementally raised relative to the energy source 210 as successive layers of the object 202 are formed.

Although FIG. 2 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

As discussed above, an additively manufactured object can be fabricated with one or more support structures that connect the object to the build platform and/or provide mechanical support for the object during fabrication and/or post-processing. Some or all of the support structures may need to be trimmed from the object before the object is ready for use. Automated trimming of support structures can be advantageous to reduce manufacturing time and increase throughput. However, conventional support structures are generally not compatible with such automated trimming systems.

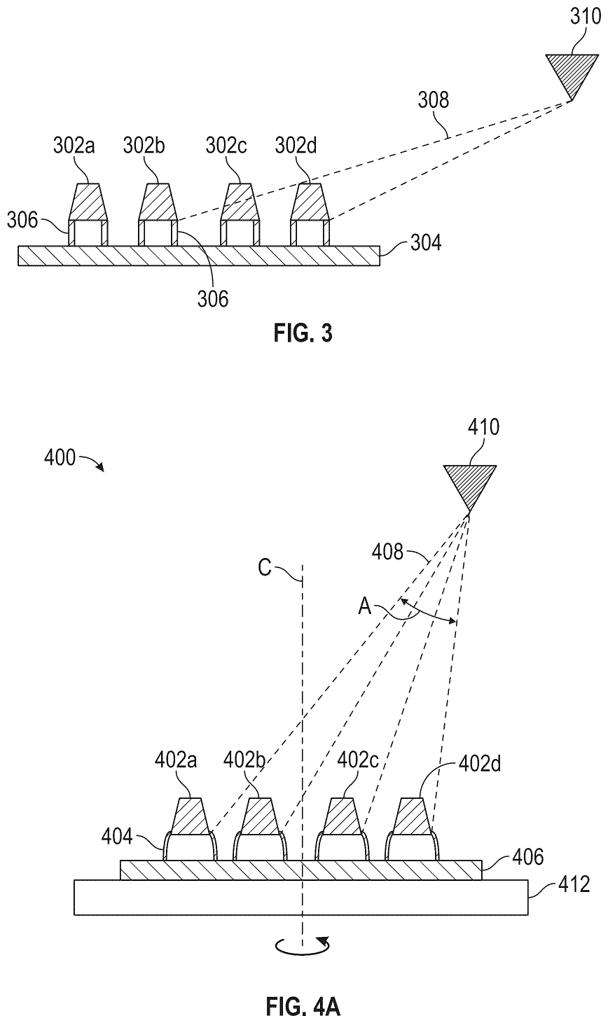

For example, FIG. 3 is a partially schematic illustration showing shadowing issues that may arise when trimming support structures from additively manufactured objects. As shown in FIG. 3, a plurality of additively manufactured objects 302a-302d (collectively, “objects 302”) are fabricated on a build platform 304, and are coupled to the build platform 304 via respective support structures 306. Each support structure 306 is a vertical strut that is connected to the lower surface of the corresponding object 302 and extends directly below the object 302 to connect to the upper surface of the build platform 304. This configuration can make it challenging for an energy beam 308 of a trimming system to reach all of the support structures 306 without passing through any of the objects 302, particularly if the energy beam 308 originates from an energy source 310 located above the build platform 304. For instance, as shown in FIG. 3, object 302c blocks the energy beam 308 from reaching the support structure 306 of the object 302b, such that the support structure 306 of the object 302b is not accessible to the energy beam 308. Although accessibility may be improved by spacing the objects 302 farther apart from each other on the build platform 304, this approach would lower the packing density on the build platform 304 and reduces manufacturing throughput.

To overcome these and other challenges, the present technology provides methods for designing support structures that are accessible to trimming systems and avoid shadowing effects. For example, a support structure can be configured to include at least one region that is sufficiently exposed so that an energy beam of the trimming system can reach the exposed region without interference from any other components that are present on the build platform (e.g., the object that the support structure is coupled to, other objects, and/or other support structures). In some embodiments, the methods herein are used to design support structures for multiple additively manufactured objects that are fabricated on the same build platform, thus ensuring that all support structures that are intended to be cut are accessible to the trimming system while also maintaining a high packing density on the build platform to increase manufacturing throughput.

FIGS. 4A and 4B are partially schematic illustrations of additively manufactured objects with support structures that are accessible to a trimming system, in accordance with embodiments of the present technology. Specifically, FIG. 4A illustrates a system 400 for trimming a plurality of additively manufactured objects 402a-402d (collectively, “objects 402”) with support structures 404, and FIG. 4B is a closeup side view of a portion of an object 402 with an individual support structure 404.

Referring first to FIG. 4A, a plurality of objects 402a-402d (collectively, “objects 402”) with support structures 404 are fabricated on a build platform 406 (e.g., a tray, plate, print bed, sheet, film, or other flattened substrate) using an additive manufacturing process. For instance, the objects 402 and support structures 404 can be fabricated from a curable material (e.g., a polymerizable resin) in a layer-by-layer additive manufacturing process (e.g., SLA, DLP), such that the objects 402 and support structures 404 are composed of a plurality of cured material layers. Although FIG. 4A illustrates four objects 402 each including two support structures 404, the techniques herein can be applied to any suitable number of objects 402 on the same build platform 406 (e.g., one, two, three, five, 10, 20, 50, or more objects 402), and each object 402 can independently include any suitable number of support structures 404, (e.g., five, 10, 20, 30, 40, 50, or more support structures 404). Each object 402 is connected to the build platform 406 via a respective set of support structures 404. The support structures 404 can be elongate members (e.g., struts, rods, arms, bridges, pins) that extend between a portion of the object 402 and the upper surface of the build platform 406.

At least some or all of the support structures 404 can be designed to be accessible to an energy beam 408 of the system 400, such as a laser beam. The energy beam 408 can be configured to cut partially or entirely through at least a portion of the support structures 404 to allow the objects 402 to be separated from the build platform 406. For instance, the energy beam 408 can be configured to ablate, burn, melt, or otherwise degrade the material of the support structures 404. In some embodiments, the energy beam 408 is used to cut entirely through a support structure 404, while in other embodiments, the energy beam 408 may cut only partially through the support structure 404 (e.g., which may make it easier to break the support structure 404 in a subsequent trimming process such as a manual trimming process).

The parameters of the energy beam 408 can be varied as desired. Examples of parameters include power, intensity, wavelength, exposure time, beam diameter, spot size, beam shape, focal point, scan speed, pulse width, pulse frequency, number of cutting passes, air assist, offset, and/or resolution. For instance, the power of the energy beam 408 can be sufficiently high to reduce the time needed to cut the support structures 404, e.g., it may take no more than 30 second, 20 seconds, 10 seconds, or 5 seconds to cut through all of the support structures 404 of a single object 402. The power of the energy beam 408 can be increased or decreased for different support structures 404 and/or objects 402, depending on the geometry of the support structure 404, extent of cutting desired, risk of damage to the neighboring object 402, etc.

The wavelength of the energy beam 408 can be selected based on the material used to form the support structures 404, e.g., a 10.6 μm wavelength can be used for cutting through support structures 404 formed from a photopolymerizable resin. Optionally, the cutting speed can be increased by adding infrared-absorbing agents to the material used to form the support structures 404. Such agents can be incorporated into the material, or can be added during the additive manufacturing process via inkjetting, DIW, spraying, and/or other suitable material deposition processes.

In some embodiments, the energy beam 408 is a focused beam, such that the energy beam 408 only has enough power to cut through material at or near the focal point of the energy beam 408. This approach can reduce the likelihood of damage to nontarget structures away from the focal point and/or improve safety.

The parameters of the energy beam 408 can optionally be adjusted to avoid the creation of sharp edges at the trimming location, such as the angle (e.g., shallower (more horizontal angles may be beneficial for avoiding sharp edges), intensity, number of passes (e.g., using multiple lower intensity passes rather than a single high intensity pass), working distance, focal point/volume, wavelength, etc. Other techniques that may be used include altering the design of the object 402 and/or support structures 404 to avoid creation of sharp edges, and/or removing sharp edges via post-processing (e.g., polishing, tumbling).

In some embodiments, the build platform 406 includes or is coupled to components to reduce or prevent reflection of the energy beam 408, which may cause trimming at undesired locations and/or damage to the objects 402. For instance, the build platform 406 can include an anti-reflective coating and/or can be made of an anti-reflective material. As another example, barriers can be formed on the build platform 406 proximate to the objects 402 during the additive manufacturing process to protect the objects 402 from damage due to reflection of the energy beam 408.

As shown in FIG. 4A, the energy beam 408 can be produced by an energy source 410 (e.g., a laser source) that is positioned above the build platform 406 and the objects 402. For example, the energy source 410 can be positioned at least 5 cm, 10 cm, 20 cm, 30 cm, 40 cm, 50 cm, or more above the upper surface of the build platform 406. Accordingly, the energy beam 408 can reach some or all of the support structures 404 from a vertical or nearly vertical location above the objects 402, which can be beneficial for reaching a greater range of locations on the build platform 406. The energy source 410 can be offset from a central axis C of the build platform 406, e.g., by at least 1 cm, 2 cm, 5 cm, 10 cm, 20 cm, or more. Alternatively, the energy source 410 can be aligned with the central axis C of the build platform 406.

In some embodiments, the energy beam 408 is movable relative to the objects 402 and the build platform 406. For instance, as shown in FIG. 4A, the energy source 410 can be configured to sweep the energy beam 408 through a plurality of different angles, e.g., using mirrors, galvo-scanners, etc. The total angular range A of the energy source 410 can be at least 10°, 20°, 30°, 40°, 45°, 50°, 60°, 70°, 80°, 90°, 100°, 110°, 120°, 130°, 135°, 140°, 150°, 160°, 170°, or 180°; and/or no more than 180°, 170°, 160°, 150°, 140°, 130°, 120°, 110°, 100°, 90°, 80°, 70°, 60°, 50°, 40°, 30°, 20°, or 10°. Although the angular range A is depicted as being a 2D shape (e.g., a fan-shaped range) in FIG. 4A, in some embodiments, the angular range A can be a 3D shape (e.g., a conical range). In other embodiments, the energy beam 408 can be stationary and has a fixed output angle from the energy source 410.

In some embodiments, the energy source 410 is movable relative to the objects 402 and build platform 406. For instance, the energy source 410 can be coupled to an actuator (e.g., a motor, gimbal, robotic arm, movable stage) that moves the energy source 410 relative to the objects 402 and build platform 406. The energy source 410 can be movable in one, two, or three degrees of freedom in translation, and/or one, two, or three degrees of freedom in rotation. In other embodiments, however, the energy source 410 can be stationary.

In some embodiments, the build platform 406 is movable relative to the energy source 410 to facilitate access to the support structures 404. For instance, the build platform 406 can be placed on or within a trimming platform 412 (e.g., a tray, plate, turntable, stage, frame, holder) that is movable, thereby causing movement of the build platform 406 relative to the energy sources 410. The trimming platform 412 can be coupled to an actuator (e.g., motor, gimbal, robotic arm) that causes translation and/or rotation of the trimming platform 412 to produce a corresponding translation and/or rotation of the build platform 406. The trimming platform 412 (and thus, the build platform 406) can be movable in one, two, or three degrees of freedom in translation; and/or one, two, or three degrees of freedom in rotation. In the illustrated embodiment, for example, the trimming platform 412 can rotate about the central axis C to cause the build platform 406 and the objects 402 thereon to rotate relative to the energy source 410. Alternatively or in combination, the trimming platform 412 can be movable in other directions, such as horizontal translation (e.g., left to right) and/or vertical translation (e.g., up and down) relative to the energy source 410. In other embodiments, however, the trimming platform 412 and the build platform 406 can be stationary.

In some embodiments, the energy source 410 is stationary, the energy beam 408 is stationary, and the trimming platform 412 is movable. In some embodiments, the energy source 410 is stationary, the energy beam 408 is movable, and the trimming platform 412 is movable. In some embodiments, the energy source 410 is movable, the energy beam 408 is movable, and the trimming platform 412 is movable. In some embodiments, the energy source 410 is movable, the energy beam 408 is movable, and the trimming platform 412 is stationary. In some embodiments, the energy source 410 is movable, the energy beam 408 is stationary, and the trimming platform 412 is stationary.

Although FIG. 4A illustrates a single energy source 410, in other embodiments, the system 400 can include a plurality of energy sources 410 (e.g., two, three, four, five, or more energy sources 410) that output a plurality of respective energy beams 408 (e.g., two, three, four, five, or more energy beams 408) toward the objects 402. In such embodiments, each energy source 410 can be positioned at a different respective location relative to the build platform 406 and the objects 402. For instance, a first energy source 410 can be positioned above the objects 402 at a first side (e.g., left side) of the central axis C, and a second energy source 410 can be positioned above the objects 402 at a second, opposite side (e.g., right side) of the central axis C. Each energy source 410 can independently move its respective energy beam 408 relative to the objects 402 and build platform 406, and/or can be independently movable relative to the objects 402 and build platform 406. Alternatively, some or all of the energy sources 410 can be stationary and/or can output a stationary energy beam 408. The use of multiple energy sources 410 may be advantageous in situations where there are a large number of objects 402 present, e.g., to provide greater flexibility in accessing the support structures 404 and/or to increase trimming speed and efficiency.

Referring next to FIG. 4B, which illustrates a representative example of a support structure 404 connected to an object 402, the support structure 404 can include an elongate body 420 having a first end portion 422 coupled to the object 402, and a second end portion 424 coupled to the build platform 406 (not shown). In the illustrated embodiment, the first end portion 422 is connected to a lateral surface of the object 402. In other embodiments, however, the first end portion 422 can be connected to another surface of the object 402, such as a lower surface or an upper surface of the object 402. Moreover, although the first end portion 422 is depicted as being connected to an external surface of the object 402, in other embodiments, the first end portion 422 can instead be connected to an internal surface of the object 402.

The support structure 404 can further include at least one exposed region 426 that is configured to be accessible to the energy beam 408 of the system 400. For example, as shown in FIG. 4B, the exposed region 426 can be located at or proximate to the first end portion 422, thus allowing the support structure 404 to be cut by the energy beam 408 at or proximate to the first end portion 422. This configuration can be advantageous for reducing the amount of the support structure 404 that remains on the object 402 after trimming, since the remaining part may need to be removed from the object 402 before the object 402 is ready for use. Optionally, to ensure that the support structure 404 is completely removed, the energy beam 408 can also cut through a portion of the object 402 that is proximate to the first end portion 422 of the support structure 404, such as a portion of the bottom and/or lateral surfaces of the object 402 that are adjacent to the first end portion 422. In such embodiments, the energy beam 408 can be directed to cut through the object 402 at a relatively shallow angle (e.g., the energy beam 408 can be within 20°, 15°, 10°, or 5° of horizontal) to avoid creating a sharp edge on the object 402, which may be undesirable for safety reasons. Alternatively or in combination, the object 402 can have a rounded surface at or near the cutting location (e.g., the lateral and/or bottom surfaces of the object 402 can be rounded) to avoid creating a sharp edge when cut.

In other embodiments, however, the exposed region 426 can be spaced apart from the first end portion 422, and/or located at or proximate to the second end portion 424, such that the energy beam 408 cuts through the support structure 404 at a location away from the first end portion 422. This configuration can be used in situations where it is acceptable to leave a part of the support structure 404 connected to the object 402. The remaining part may optionally be removed in a subsequent process, such as an additional trimming process and/or a polishing process, or may be left as part of the object 402.

The exposed region 426 can be a portion of the support structure 404 that extends laterally away from the object 402, such that the exposed region 426 lies outside of the footprint of the object 402 (e.g., no portion of the exposed region 426 is vertically below any portion of the object 402). For instance, the exposed region 426 can be a portion of the support structure 404 that is curved, angled, or otherwise extends laterally away from the object 402 to form a shoulder that is accessible to the energy beam 408. Optionally, the exposed region 426 can be a weakened portion of the support structure 404 to facilitate cutting of the exposed region 426 by the energy beam 408. For instance, the exposed region 426 can be tapered or otherwise made thinner than the rest of the support structure 404. As another example, the exposed region 426 can include perforations, gaps, grooves, etc., formed therein. In a further example, the exposed region 426 can be made partially or entirely out of a weaker material than the rest of the support structure 404.

The geometry of the support structure 404 can be varied as desired to provide accessibility to the energy beam 408, which may depend on the number of energy sources 410 present, the location(s) of the energy source(s) 410, the range of the energy beam(s) 408 produced by the energy source(s) 410, the number and positions of the objects 402 on the build platform 406, the geometries of the objects 402 and their respective support structures 404, the spacing of the objects 402 on the build platform 406, the movement range of the build platform 406, etc. Moreover, the geometry of the support structure 404 can be configured to provide sufficient structural integrity to support the object 402 during additive manufacturing and post-processing, maintain printability (e.g., extremely thin support structures 404 may be challenging to print, support structures 404 with long unsupported overhangs may be prone to collapse), reduce time and/or energy needed to cut through the support structure 404 (e.g., thinner support structures 404 may be cut faster and/or with less energy than thicker support structures 404), reduce or minimize the amount of material used to form the support structure 404, maintain a high packing density of objects 402 on the build platform 406 (e.g., longer support structures 404 may take up more space on the build platform 406), and/or other relevant considerations.

For instance, the total length L_{T} of the body 420 of the support structure 404 can be within a range from 2 mm to 50 mm, 2 mm to 20 mm, 2 mm to 10 mm, 2 mm to 5 mm, 5 mm to 50 mm, 5 mm to 20 mm, 5 mm to 10 mm, 10 mm to 50 mm, 10 mm to 20 mm, or 20 mm to 50 mm. In some embodiments, only a portion of the support structure 404 is accessible to the energy beam 408 (e.g., the exposed region 426 is no more than 10%, 20%, 30%, 40%, 50%, 60%, 70%, 80%, or 90% of the total length L_{T} of the body 420 of the support structure 404). In other embodiments, however, the entire support structure 404 is accessible to the energy beam (e.g., the exposed region 426 spans the entire length L_{T} of the body 420). The horizontal length L_{H} of the body 420 of the support structure 404 can be sufficiently long to create the exposed region 426, but sufficiently short so the support structure 404 can be successfully fabricated and post-processed without collapsing (e.g., due to excessive overhang) and/or to allow for tighter packing of multiple objects 402 on the build platform 406. For instance, the horizontal length L_{H} can be within a range from 1 mm to 20 mm, 1 mm to 15 mm, 1 mm to 10 mm, 1 mm to 5 mm, 5 mm to 20 mm, 5 mm to 15 mm, 5 mm to 10 mm, 10 mm to 20 mm, 10 mm to 15 mm, or 15 mm to 20 mm. In some embodiments, the horizontal length L_{H} is no more than 90%, 80%, 70%, 60%, 50%, 40%, 30%, 20%, or 10% of the height H of the support structure 404.

The body 420 of the support structure can have any suitable thickness (e.g., diameter), such as a thickness within a range from 0.1 mm to 5 mm, 0.1 mm to 2 mm, 0.1 mm to 1 mm, 0.1 mm to 0.5 mm, 0.1 mm to 0.3 mm, 0.3 mm to 5 mm, 0.3 mm to 2 mm, 0.3 mm to 1 mm, 0.3 mm to 0.5 mm, 0.5 mm to 5 mm, 0.5 mm to 2 mm, 0.5 mm to 1 mm, 1 mm to 5 mm, 1 mm to 2 mm, or 2 mm to 5 mm. Thinner support structures may be faster to cut and/or may require less energy to cut, but may be more challenging to print and/or may provide less structural support for the object 402. The body 420 may have a uniform thickness, or may have a variable thickness (e.g., the exposed region 426 may be thinner than the remaining portions of the body 420). For instance, the first end portion 422 and/or the exposed region 426 can have a thickness T₁, and the second end portion 424 can have a thickness T₂ which can be greater than, less than, or equal to the thickness T₁. In some embodiments, the thickness T₁ is less than the thickness T₂ by at least 0.1 mm, 0.2 mm, 0.3 mm, 0.4 mm, 0.5 mm, 0.6 mm, 0.7 mm, 0.8 mm, 0.9 mm, 1 mm, or 2 mm; or the thickness T₂ is less than the thickness T₁ by at least 0.1 mm, 0.2 mm, 0.3 mm, 0.4 mm, 0.5 mm, 0.6 mm, 0.7 mm, 0.8 mm, 0.9 mm, 1 mm, or 2 mm. The thickness T₁ and the thickness T₂ can each be independently selected from any of the following ranges: a range from 0.1 mm to 5 mm, 0.1 mm to 2 mm, 0.1 mm to 1 mm, 0.1 mm to 0.5 mm, 0.1 mm to 0.3 mm, 0.3 mm to 5 mm, 0.3 mm to 2 mm, 0.3 mm to 1 mm, 0.3 mm to 0.5 mm, 0.5 mm to 5 mm, 0.5 mm to 2 mm, 0.5 mm to 1 mm, 1 mm to 5 mm, 1 mm to 2 mm, or 2 mm to 5 mm.

In the illustrated embodiment, the support structure 404 includes a base 428 that is connected to the second end portion 424, and is interposed between the second end portion 424 and the surface of the build platform. The base 428 can be wider than the body 420 to improve stability (e.g., by enhancing adhesion to the build platform), while also reducing material usage compared to a support structure that is wider throughout the entire length of the body. For instance, the base 428 can have a thickness that is greater than the thickness of the body 420 (e.g., the thickness T₂ of the second end portion 424 of the body 420) by at least 0.1 mm, 0.2 mm, 0.3 mm, 0.4 mm, 0.5 mm, 0.6 mm, 0.7 mm, 0.8 mm, 0.9 mm, 1 mm, or 2 mm. In the illustrated embodiment, the base 428 has a tapered shape in which a thickness T₃ of the top of the base 428 is smaller than a thickness T₄ of the bottom of the base 428. For instance, the thickness T₃ can be greater than the thickness T₄ by at least 0.1 mm, 0.2 mm, 0.3 mm, 0.4 mm, 0.5 mm, 0.6 mm, 0.7 mm, 0.8 mm, 0.9 mm, 1 mm, or 2 mm. In other embodiments, however, the thickness T₃ can be equal to the thickness T₄, or the thickness T₄ can be greater than the thickness T₃ by at least 0.1 mm, 0.2 mm, 0.3 mm, 0.4 mm, 0.5 mm, 0.6 mm, 0.7 mm, 0.8 mm, 0.9 mm, 1 mm, or 2 mm. The thickness T₃ and the thickness T₄ can each be independently selected from any of the following ranges: a range from 0.1 mm to 5 mm, 0.1 mm to 2 mm, 0.1 mm to 1 mm, 0.1 mm to 0.5 mm, 0.1 mm to 0.3 mm, 0.3 mm to 5 mm, 0.3 mm to 2 mm, 0.3 mm to 1 mm, 0.3 mm to 0.5 mm, 0.5 mm to 5 mm, 0.5 mm to 2 mm, 0.5 mm to 1 mm, 1 mm to 5 mm, 1 mm to 2 mm, or 2 mm to 5 mm. In other embodiments, however, the base 428 can be omitted, such that the second end portion 424 of the body 420 is connected directly to the surface of the build platform.

The height H of the support structure 404 (including the height of the base 428, if present) can be within a range from 2 mm to 50 mm, 2 mm to 20 mm, 2 mm to 10 mm, 2 mm to 5 mm, 5 mm to 50 mm, 5 mm to 20 mm, 5 mm to 10 mm, 10 mm to 50 mm, 10 mm to 20 mm, or 20 mm to 50 mm. In embodiments where the base 428 is present, the height of the base 428 can constitute no more than 90%, 80%, 70%, 60%, 50%, 40%, 30%, 20%, or 10% of the height H of the support structure 404.

The body 420 of the support structure 404 can have any suitable cross-sectional shape, such as circular, oval, square, rectangular, triangular, pentagonal, hexagonal, or any other polygonal or non-polygonal shape. The base 428 of the support structure 404, if present, can also have any suitable cross-sectional shape, such as circular, oval, square, rectangular, triangular, pentagonal, hexagonal, or any other polygonal or non-polygonal shape.

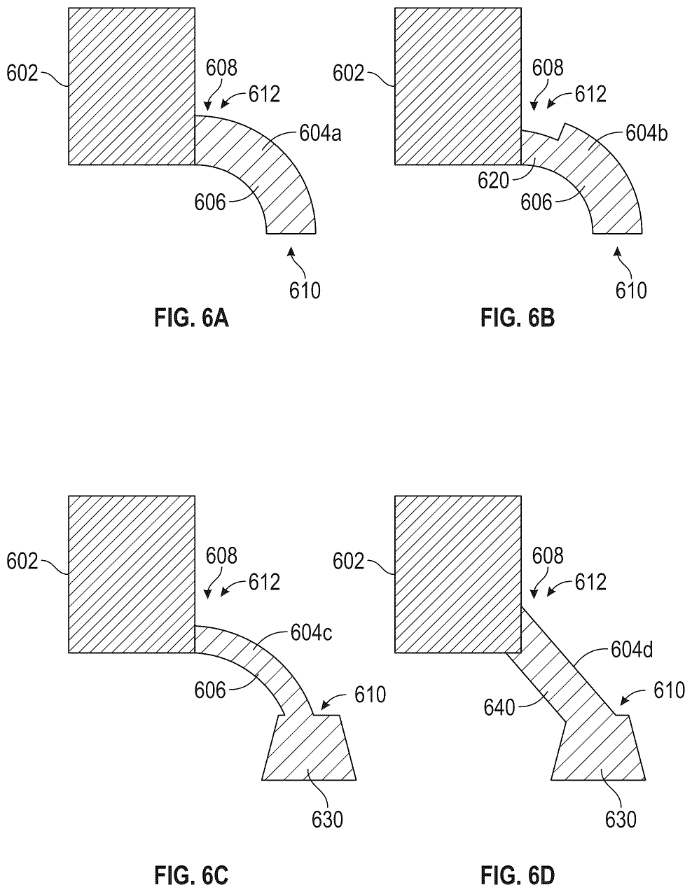

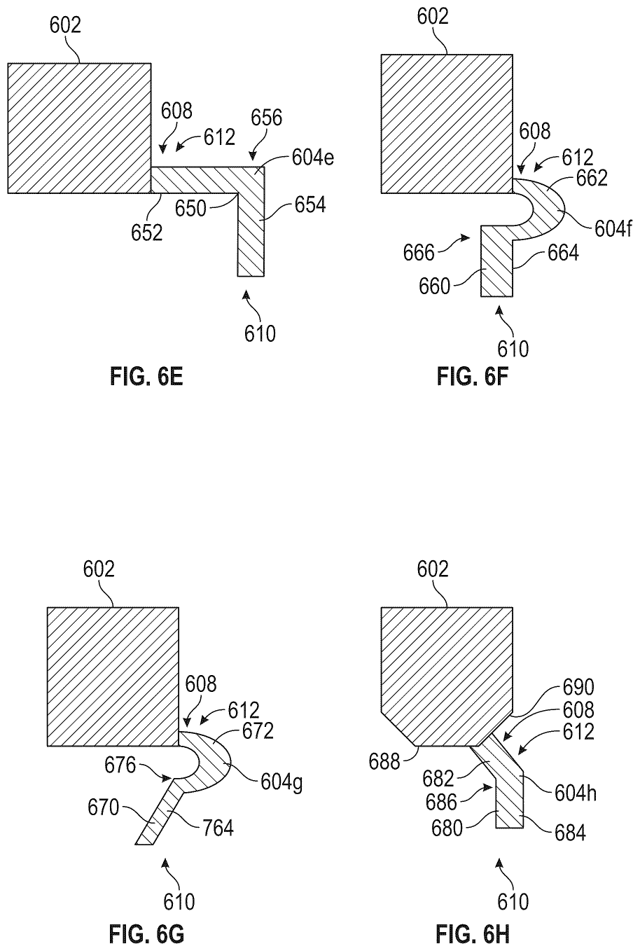

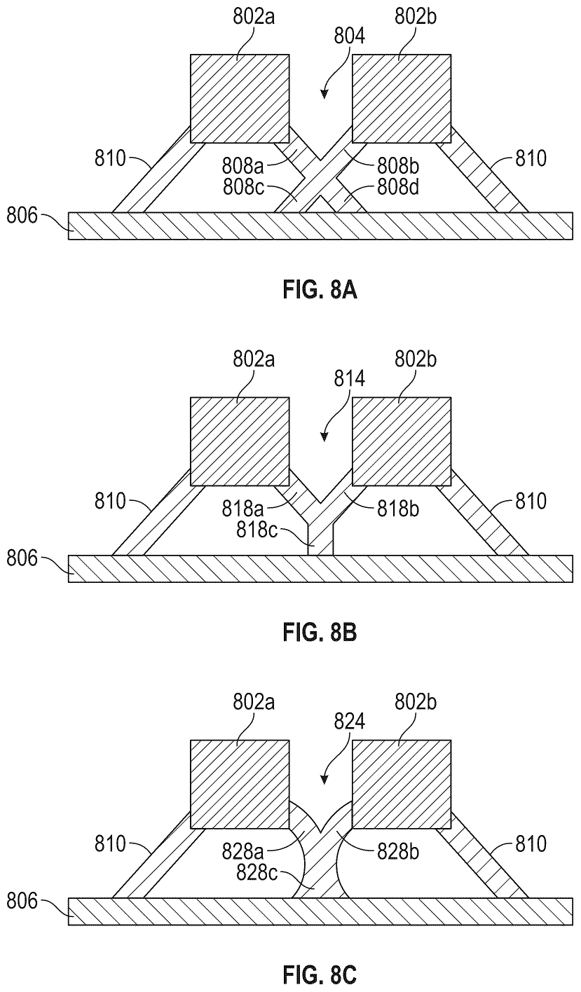

Additional details and examples of geometries that may be used for the support structure 404 are described further below in connection with FIGS. 6A-6H and 8A-8C.

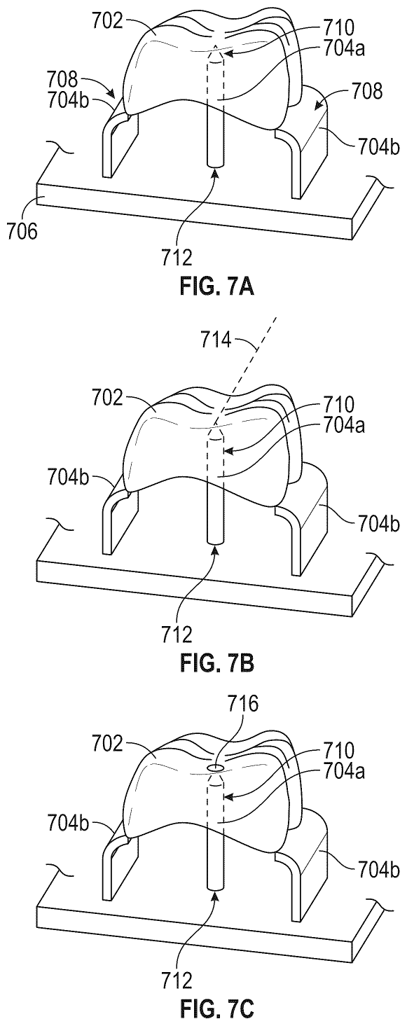

Referring to FIGS. 4A and 4B together, the number, geometry, and type of support structures 404 used for an individual object 402 may vary depending on the geometry of the object 402, material used to form the object 402, location of the object 402 on the build platform 406, location of the object 402 relative to the energy source 410, spacing between the object 402 and other objects 402, and/or other relevant considerations. For instance, different support structures 404 can have different shapes, lengths, heights, thicknesses, etc. In some embodiments, the entire length and/or perimeter of an object 402 is supported by support structures 404, while in other embodiments, only certain sections of the object 402 may be supported by support structures 404 (e.g., support structures 404 may be present only at the lowest point(s) of the object 402 and/or may be omitted for non-critical portions of the object 402). Some or all of the support structures 404 of an object 402 can have exposed regions 426. Optionally, some of the support structures 404 of an object 402 may not have exposed regions, e.g., the support structures 404 can extend vertically below the object 402 and/or be positioned entirely within the footprint of the object 402 (e.g., similar to the support structures 306 of FIG. 3), and/or the support structures 404 may be connected to internal portions of the object 402 (e.g., as described below in connection with FIGS. 7A-7C).

In some embodiments, all of the support structures 404 connected to an object 402 are trimmed by the energy beam 408. In other embodiments, only some of the support structures 404 of an object 402 are trimmed by the energy beam 408, while the remaining support structures 404 are not trimmed by the energy beam 408. For instance, the remaining support structures 404 can include support structures 404 without exposed regions, such as support structures 404 located vertically below the object 402 and/or positioned entirely within the footprint of the object 402, and/or support structures 404 connected to internal portions of the object 402. Optionally, the remaining support structures 404 can include support structures 404 with exposed regions 426. In some embodiments, the remaining support structures 404 are trimmed by a different process (e.g., manual trimming), which may occur before or after the trimming of the other support structures 404 by the energy beam 408. In some embodiments, the remaining support structures 404 are left intact while the other support structures 404 are trimmed by the energy beam 408, which can be beneficial for ensuring that the objects 402 do not fall, collapse, sag, deflect, or otherwise move during the trimming process, which may interfere with trimming accuracy.

Optionally, some support structures 404 can be configured as a mesh or similar structure including holes, gaps, perforations, pores, etc., in an otherwise solid sheet to allow residual material (e.g., uncured resin) to move laterally relative to the build platform 406 without being blocked by the support structures 404. This approach can facilitate removal of residual material from the objects 402 and build platform 406 via centrifugation by allowing the residual material to flow off the surface of the build platform 406, before the objects 402 and build platform 406 are trimmed by the system 400.

FIG. 5 is a perspective view of an additively manufactured dental appliance 500 including a plurality of support structures 502, in accordance with embodiments of the present technology. The appliance 500 can be any of the dental appliances described herein, such as an aligner, palatal expander, attachment placement device, retainer, etc. In the illustrated embodiment, the appliance 500 includes a shell 504 having a plurality of cavities configured to receive some or all of a patient's teeth. The shell 504 can be fabricated in a horizontal, “tooth tips up” configuration in which the occlusal surfaces 506 of the shell 504 are oriented upward and away from the build platform (not shown), and the gingival edges 508 of the shell 504 are oriented downward and toward the build platform. The support structures 502 can be coupled to the external surfaces of the shell 504 at or near the gingival edges 508, such as the external buccal surface, the external lingual surface, and/or the external bottom surfaces of the gingival edges 508. Optionally, some support structures 502 can be coupled to an internal surface of the shell 504, such as an internal occlusal surface, an internal buccal surface, and/or an internal lingual surface (e.g., as described below in connection with FIGS. 7A-7C).

The distribution of the support structures 502 along the shell 504 can be varied as desired. For instance, the support structures 502 can be distributed along the entire perimeter and/or arch of the shell 504. Alternatively, the support structures 502 can be localized to certain portions of the perimeter and/or arch of the shell 504, such as the mesial, distal, buccal, and/or lingual portions of the shell 504. In some embodiments, some or all of the support structures 502 are located at or proximate to the lowest regions of the shell 504, such as the regions corresponding the gingival apices of the cavities of the shell 504. Optionally, certain portions of the shell 504 may not include any support structures 502, such as the interproximal portions of the shell 504.

Some or all of the support structures 502 can be configured with exposed regions that are accessible to a trimming system, e.g., as described herein with respect to FIGS. 4A and 4B and further below with respect to FIGS. 6A-6H. Optionally, the appliance 500 can include one or more additional support structures that are coupled to an internal portion of the shell 504, e.g., as described further below in connection with FIGS. 7A-7C.

Although FIG. 5 illustrates an example configuration of a dental appliance 500 with support structures 502, in other embodiments, the appliance 500 and support structures 502 can be configured differently. For instance, the appliance 500 can instead be fabricated in a “tooth tips down” configuration in which the occlusal surfaces 506 of the shell 504 are oriented downward and toward the build platform, and the gingival edges 508 of the shell 504 are oriented upward and away the build platform. Moreover, although the appliance 500 is depicted in a horizontal configuration in which the mesial-distal axis of the appliance 500 is parallel or substantially parallel to the build platform, the appliance 500 can alternatively be fabricated in a tiled configuration in which the mesial-distal axis is angled relative to the build platform, or in a vertical configuration in which the mesial-distal axis is orthogonal or substantially orthogonal to the build platform.

FIGS. 6A-6H illustrate representative examples of support structures configured in accordance with embodiments of the present technology. Any of the features of the embodiments of FIGS. 6A-6H can be combined with each other and/or with any of the other embodiments of support structures described herein (e.g., the embodiments of FIGS. 4A and 4B, 5, 7A-7C, and 8A-8C).

FIG. 6A is a partially schematic side view of an additively manufactured object 602 with a support structure 604a, in accordance with embodiments of the present technology. The support structure 604a includes an elongate curved body 606 including a first end portion 608 connected to a lateral surface of the object 602, and a second end portion 610 connected to a build platform (not shown). The curved body 606 can extend away from the object 602 to create an exposed region 612 at or near the first end portion 608 that is accessible to an energy trimming system, e.g., as previously described in connection with FIGS. 4A and 4B.

FIG. 6B is a partially schematic side view of an additively manufactured object 602 with a support structure 604b, in accordance with embodiments of the present technology. The support structure 604b is generally similar to the support structure 604a of FIG. 6A, except that the curved body 606 of the support structure 604b includes a narrower neck 620 having a reduced thickness compared to the rest of the body 606. In the illustrated embodiment, the neck 620 is located at the first end portion 608 and is immediately adjacent to the object 602. In other embodiments, however, the neck 620 may be spaced apart from the body 606, e.g., the first end portion 608 can be wider than the neck 620. The neck 620 can be located within the exposed region 612 of the support structure 604b to facilitate cutting of the exposed region 612 by an energy beam. For instance, the neck 620 can be a notch, channel, recess, groove, perforation, etc., that is formed in the body 606 to reduce the amount of material to be cut by the energy beam, which can reduce the time needed to cut through the exposed region 612 of the support structures 604b.

FIG. 6C is a partially schematic side view of an additively manufactured object 602 with a support structure 604c, in accordance with embodiments of the present technology. The support structure 604c is generally similar to the support structures 604a, 604b of FIGS. 6A and 6B, except that the body 606 of the support structure 604c is coupled to the build platform via a wider base 630, e.g., similar to the embodiment illustrated in FIG. 4B. The base 630 can improve stability and adhesion to the build platform, while keeping the exposed region 612 relatively narrow for faster cutting speeds.

FIG. 6D is a partially schematic side view of an additively manufactured object 602 with a support structure 604d, in accordance with embodiments of the present technology. The support structure 604d is generally similar to the support structure 604c of FIG. 6C, except that the support structure 604d includes a linear body 640 rather than a curved body. The linear body 640 can be angled away from the object 602 to create an exposed region 612. For instance, the angle between the lateral surface of the object 602 and the body 640 can be greater than or equal to 5°, 10°, 15°, 20°, 25°, 30°, 35°, 40°, or 45°. Although FIG. 6D illustrates the linear body 640 as being connected to the build platform via a wider base 630, the base 630 can be omitted such that the linear body 640 is instead connected directly to the build platform.

FIG. 6E is a partially schematic side view of an additively manufactured object 602 with a support structure 604e, in accordance with embodiments of the present technology. The support structure 604e includes a body 650 composed of a horizontal segment 652 and a vertical segment 654. The horizontal segment 652 can extend from the first end portion 608 to a joint portion 656, and the vertical segment 654 can extend from the joint portion 656 to the second end portion 610. The horizontal segment 652 can extend laterally away from the object 402 to create an exposed region 612. The length of the horizontal segment 652 can be sufficiently long to be accessible to the trimming system, but sufficiently short for printability and/or to increase packing density on the build platform. For instance, the length of the horizontal segment 652 can be within a range from 1 mm to 20 mm, 1 mm to 15 mm, 1 mm to 10 mm, 1 mm to 5 mm, 5 mm to 20 mm, 5 mm to 15 mm, 5 mm to 10 mm, 10 mm to 20 mm, 10 mm to 15 mm, or 15 mm to 20 mm. Although the joint portion 656 of the body 650 is depicted as being a sharp corner, the joint portion 656 can alternatively be configured as a rounded corner (e.g., to reduce stress concentration). Moreover, although the vertical segment 654 is depicted as being at 900 angle relative to the horizontal segment 652), in other embodiments, the vertical segment 654 can instead be angled, e.g., slightly toward or away from the horizontal segment 652.

FIG. 6F is a partially schematic side view of an additively manufactured object 602 with a support structure 604f, in accordance with embodiments of the present technology. The support structure 604f includes a body 660 composed of a curved segment 662 and a vertical segment 664. The curved segment 662 can extend from the first end portion 608 to a joint portion 666, and the vertical segment 664 can extend from the joint portion 666 to the second end portion 610. As shown in FIG. 6F, the vertical segment 662 can be positioned vertically below the object 602, such that the vertical segment 662 is entirely within the footprint of the object 602. However, the curved segment 662 can curve laterally away from the object 602 and the vertical segment 662 to create an exposed region 612 that lies outside of the footprint of the object 602 and is therefore accessible to an energy trimming system.

FIG. 6G is a partially schematic side view of an additively manufactured object 602 with a support structure 604g, in accordance with embodiments of the present technology. The support structure 604g can be generally similar to the support structure 604f of FIG. 6F, except that the body 670 of the support structure 604g includes a curved segment 672 and an angled segment 674. The curved segment 672 can extend from the first end portion 608 to a joint portion 676, and the angled segment 674 can extend from the joint portion 676 to the second end portion 610. As shown in FIG. 6G, the angled segment 672 can be positioned vertically below the object 602, such that the angled segment 672 is partially or entirely within the footprint of the object 602. However, the curved segment 672 can curve laterally away from the object 602 and the angled segment 672 to create an exposed region 612 that lies outside of the footprint of the object 602 and is therefore accessible to an energy trimming system.

FIG. 6H is a partially schematic side view of an additively manufactured object 602 with a support structure 604h, in accordance with embodiments of the present technology. The support structure 604h includes a body 680 composed of an angled segment 682 and a vertical segment 684. The angled segment 682 can extend from the first end portion 608 to a joint portion 686, and the vertical segment 684 can extend from the joint portion 686 to the second end portion 610. In the illustrated embodiment, the first end portion 608 of the body 680 is coupled to a bottom surface 688 of the object 602, rather than to a lateral surface. The angled segment 682 can be angled away from the interface between the first end portion 608 and the bottom surface 688 to create an exposed region 612 that is accessible to an energy trimming system. The bottom surface can include an undercut 690 formed therein proximate to the first end portion 608 and the angled segment 682 to facilitate access to the exposed region 612. In such embodiments, the angled segment 682 may lie partially or entirely within the footprint of the object 602, as long as the undercut is sufficiently large to allow an energy beam to reach the exposed region 612.

In some embodiments, the additively manufactured objects described herein include at least one support structure that is coupled to an internal portion of the object, rather than to an external portion of the object. Such support structures, which may be referred to herein as “internal support structures,” can be used to stabilize overhangs, bridges, islands, valleys, etc., that are present within the internal portions of the object (e.g., within a cavity, hole, recess, etc., of the object). In some embodiments, the internal support structure does not include any exposed regions that are accessible to an energy beam of the trimming system, such that the internal support structure cannot be reached without the energy beam passing through a portion of the object. Accordingly, the internal support structure may not be cut by the energy beam during the trimming process, and may instead be removed from the object in a separate removal process (e.g., manual removal). Alternatively, the trimming process can involve cutting through a portion of the object to trim the internal support structure, e.g., if the cutting of the object portion is not expected to substantially affect the function of the object. In some embodiments, internal support structures are trimmed or otherwise removed only after some or all of the other support structures of the additively manufactured object are trimmed. By keeping the internal support structure intact while the other support structures are trimmed, the object can be prevented from moving, collapsing, deflecting, etc., during the trimming process, which may interfere with accurate trimming of the support structures.

FIG. 7A-7C are perspective views of an additively manufactured object 702 with an internal support structure 704a, in accordance with embodiments of the present technology. In the illustrated embodiment, the object 702 is a shell of a dental appliance, e.g., similar to the shell 504 of FIG. 5. The object 702 is connected to a build platform 706 via a plurality of support structures, such as at least one internal support structure 704a and at least one additional support structure 704b (collectively, “support structures 704”).

The support structures 704b (also known as “external support structures”) can be elongate members (e.g., struts, rods, arms, bridges, pins) that are each coupled to an external portion of the object 702 (e.g., to an external lateral and/or bottom surface of the object 702). Each external support structure 704b can include an exposed region 708 that is accessible to a trimming system, as described elsewhere herein. For instance, in the illustrated embodiment, the external support structures 704b are curved away from the lateral surfaces of the object 702 to form a shoulder that can be cut by an energy beam of the trimming system. In other embodiments, however, some or all of the external support structures 704b can instead be vertical support structures that extend directly below the object 702 (e.g., similar to the support structures 306 of FIG. 3). Although the external support structures 704b are depicted as being wide bridges that extend along the perimeter of the object 702, the external support structures 704b can alternatively be configured as narrower struts, or any of the other embodiments disclosed herein. Moreover, although FIG. 7A illustrates two external support structures 704b, the object 702 can include any suitable number of external support structures 704b, such as five, 10, 15, 20, 30, 40, 50, or more external support structures 704b.

The internal support structure 704a can be an elongate member (e.g., strut, rod, arm, bridge) having a first end portion 710 coupled to an internal portion of the object 702, and a second end portion 712 coupled to the build platform 706. The internal portion can be an internal surface of the object 702, such as an internal surface that is oriented downward (e.g., toward the build platform 706) or an internal surface that is oriented laterally. For example, in embodiments where the object 702 is a shell of a dental appliance, the first end portion 710 can be connected to an internal surface of the shell, such as an internal surface of a cavity configured to receive one or more of a patient's teeth. In the illustrated embodiment, the first end portion 710 of the internal support structure 704a is connected to an internal occlusal surface of a cavity of the shell (e.g., the lowest point on the internal occlusal surface). In other embodiments, however, the first end portion 710 can be connected to another internal surface of the cavity, such as an internal buccal surface or an internal lingual surface of a cavity of the shell.

In some embodiments, the entire internal support structure 704a is located vertically below the object 702 (e.g., within the footprint of the object 702). In such embodiments, the internal support structure 704a may not include any exposed regions that are accessible to a trimming system, e.g., an energy beam cannot reach the internal support structure 704a without passing through another portion of the object 702. In other embodiments, however, the internal support structure 704a may include an exposed region that extends outside of the footprint of the object 702, and/or the object 702 can include an undercut to allow access to the support structure 704a (e.g., similar to the undercut 690 in FIG. 6H).

In some embodiments, the external support structures 704b are configured to be cut by an energy beam of a trimming system (e.g., the system 400 of FIG. 4A), while the internal support structure 704a is not cut by the energy beam (e.g., and is instead removed from the object 702 via a different trimming process, such as manual trimming). In such embodiments, the internal support structure 704a can stabilize the object 702 during the trimming of the external support structures 704b so the object 702 remains in a fixed position and orientation. This approach can reduce or prevent the object 702 from falling, collapsing, sagging, deflecting, etc., as the other support structures 704b are cut, which could interfere with targeting of the energy beam to the correct locations for trimming and/or could interfere with the trimming of other objects on the same build platform.

In other embodiments, the internal support structure 704a is configured to be cut by an energy beam of a trimming system (e.g., the system 400 of FIG. 4A), which may be the same trimming system used to cut the external support structures 704b, or may be a different trimming system. Energy-based trimming may be advantageous to avoid leaving small opaque spots on the object 702, which may occur when the internal support structure 704a is removed by manual trimming. In such embodiments, the trimming system may also cut through a portion of the object 702 to reach the internal support structure 704a. For example, as shown in FIG. 7B, an energy beam 714 can be directed to an external surface of the object 702 that is proximate to the first end portion 710 of the internal support structure 704a. The energy beam 714 can cut through the thickness of the object 702 to reach and sever the connection between the first end portion 710 and the internal portion of the object 702, thereby separating the internal support structure 704a from the object 702. The first end portion 710 can be narrower than the rest of the internal support structure 704a to facilitate cutting of the first end portion 710. In the illustrated embodiment, for example, the first end portion 710 has a tapered (e.g., conical) shape such that the connection between the first end portion 710 and the internal portion of the object 702 is thinner than the rest of the internal support structure 704a. In some embodiments, the internal support structure 704a is trimmed only after the external support structures 704b are trimmed, thus allowing the internal support structure 704a to stabilize the object 702 during the trimming of the external support structures 704b, as discussed herein. In other embodiments, however, the internal support structure 704a can be trimmed concurrently with or before some or all of the external support structures 704b are trimmed.

As shown in FIG. 7C, the trimming of the internal support structure 704a by the energy beam 714 can leave a hole 716 in the object 702 at or near the first end portion 710 of the internal support structure 704a. The thickness (e.g., width and/or diameter) of at least the first end portion 710 of the internal support structure 704a can be sufficiently small so that the resulting hole 716 does not interfere with the mechanical integrity and function of the object 702. For instance, the thickness of the first end portion 710 and/or the diameter of the hole 716 can be no greater than 2 mm, 1.5 mm, 1 mm, 0.5 mm, 0.2 mm, or 0.1 mm.

The parameters of the energy beam 714 used to trim the internal support structure 704a may differ from the parameters used to trim the external support structures 704b. For instance, the internal support structure 704a can be trimmed using lower power, higher cutting speed, smaller spot size, and/or higher air assist compared to the external support structures 704b, e.g., to achieve better surface quality, for example, to provide more accurate force application in embodiments where the object 702 is a dental appliance. The parameters for trimming the external support structures 704b can be optimized for trimming efficiency (e.g., faster cutting speeds).

Although FIGS. 7A-7C illustrate an object 702 with a single internal support structure 704a, in other embodiments, the object 702 can include any suitable number of internal support structures 704a, such as two, three, four, five, 10, 20, 30, 40, 50, or more internal support structures 704a. For instance, in embodiments where the object 702 is a shell of a dental appliance, some or all of the cavities of the shell can include at least one internal support structure 704a (e.g., an internal support structure 704a coupled to an occlusal surface of the cavity). Optionally, the internal support structures 704a can be localized to certain portions of the shell, such as the mesial portion, distal portion, portions that receive one or more molars, portions that receive one or more incisors, portions that receive one or more canines, portions that receive one or more premolars, or suitable combinations thereof. In some embodiments, the geometry of the shell is optimized to reduce the number and size of islands in the shell—and thus, the number of internal support structures 704a used to support the islands during additive manufacturing—using techniques such as closing radius and fillet radius.

In some embodiments, the present technology provides support structures that are coupled to a plurality of additively manufactured objects (e.g., two, three, four, five, or more objects), rather than to a single object. Such support structures may be referred to herein as an “interconnected support structures.” The use of interconnected structures can allow for greater packing densities of objects on a single build platform, since some or all of the objects can share support structures.

FIGS. 8A-8C are partially schematic side views of additively manufactured objects with interconnected support structures, in accordance with embodiments of the present technology. Any of the features of the embodiments of FIGS. 8A-8C can be combined with each other and/or with any of the other embodiments of support structures described herein (e.g., the embodiments of FIGS. 4A and 4B, 5, 6A-6H, and 7A-7C).

FIG. 8A is a partially schematic side view of two additively manufactured objects 802a, 802b with an interconnected support structure 804, in accordance with embodiments of the present technology. The interconnected support structure 804 is coupled to both of the objects 802a, 802b and to a build platform 806. In the illustrated embodiment, the interconnected support structure 804 is a branched (e.g., cross-shaped) structure including four branches: a first branch 808a connected to the object 802a, a second branch 808b connected to the object 802b, a third branch 808c connected to the build platform 806, and a fourth branch 808d connected to the build platform 806. The first and second branches 808a, 808b can be angled members that extend laterally away from the respective objects 802a, 802b to form exposed regions that are accessible to a trimming system, as described elsewhere herein. Accordingly, the objects 802a, 802b can be separated from each other and from the build platform 806 by cutting through the first and second branches 808a, 808b of the interconnected support structure 804.

Optionally, the objects 802a, 802b may be coupled to the build platform 806 by one or more additional support structures 810, which may be interconnected with other objects (e.g., similar to the interconnected support structure 804) or may not be interconnected with other objects. The additional support structures 810 can be configured according to any of the embodiments described herein (e.g., the embodiments of FIGS. 4A and 4B, 5, 6A-6H, and 7A-7C).

FIG. 8B is a partially schematic side view of two additively manufactured objects 802a, 802b with another interconnected support structure 814, in accordance with embodiments of the present technology. The interconnected support structure 814 can be generally similar to the interconnected support structure 804 of FIG. 8A, except that the interconnected structure 814 is a branched (e.g., Y-shaped) structure with three branches: a first branch 818a connected to the object 802a, a second branch 818b connected to the object 802b, and a third branch 818c connected to the build platform 806. The first and second branches 818a, 818b can be angled members that extend laterally away from the respective objects 802a, 802b to form exposed regions that are accessible to a trimming system, as described elsewhere herein. Accordingly, the objects 802a, 802b can be separated from each other and from the build platform 806 by cutting through the first and second branches 818a, 818b of the interconnected support structure 814.

FIG. 8C is a partially schematic side view of two additively manufactured objects 802a, 802b with yet another interconnected support structure 824, in accordance with embodiments of the present technology. The interconnected support structure 824 can be generally similar to the interconnected support structure 814 of FIG. 8B, except that the interconnected structure 824 has curved branches rather than straight branches. Specifically, the interconnected structure 82 includes a first curved branch 828a connected to the object 802a, a second curved branch 828b connected to the object 802b, and a third branch 828c (which may be curved or straight) connected to the build platform 806. The first and second curved branches 828a, 828b can be curved members that extend laterally away from the respective objects 802a, 802b to form exposed regions that are accessible to a trimming system, as described elsewhere herein. Accordingly, the objects 802a, 802b can be separated from each other and from the build platform 806 by cutting through the first and second curved branches 828a, 828b of the interconnected support structure 824.

Although FIGS. 8A-8C illustrate two additively manufactured objects coupled to an interconnected support structure, the embodiments of FIGS. 8A-8C can be modified to couple to any suitable number of objects, such as three, four, five, or more objects. For instance, the interconnected support structures of FIGS. 8A-8C can be configured with a plurality of branches, with each branch being coupled to a respective object or to the build platform. A single object can be coupled to multiple branches of an interconnected support structure, or to a single branch of the interconnected support structure. Some or all of the branches of an interconnected support structure can be configured with an exposed region for cutting by a trimming system, as described herein.

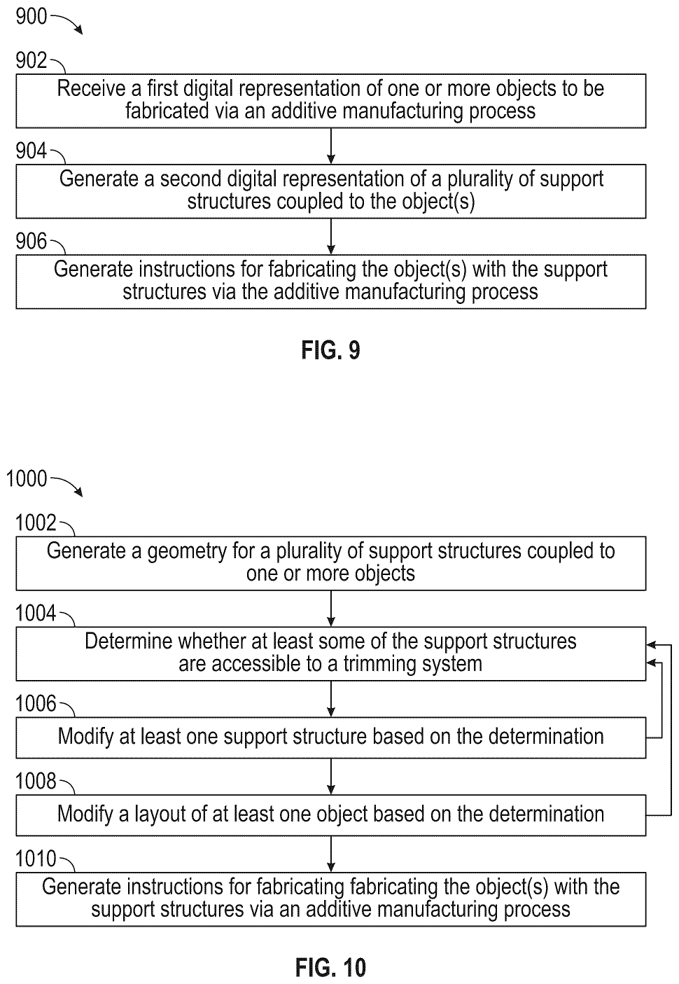

FIG. 9 is a flow diagram illustrating a method 900 for generating support structures for additively manufactured objects, in accordance with embodiments of the present technology. The method 900 can be used to design any of the support structures described herein. In some embodiments, some or all of the processes of the method 900 are implemented as computer-readable instructions (e.g., program code) that are configured to be executed by one or more processors of a computing device, such as a computing device of an appliance design system.

The method 900 can begin at block 902 with receiving a first digital representation of one or more objects to be fabricated via an additive manufacturing process. For example, the objects can include one or more dental appliances (e.g., aligners, palatal expanders, attachment placement devices, retainers). The first digital representation can include one or more 3D models (e.g., a surface model, mesh model, parametric model) representing the 3D geometry of the objects. In some embodiments, the first digital representation corresponds to a plurality of objects to be fabricated on the same build platform in a single additive manufacturing operation. In such embodiments, the first digital representation can show the layout (e.g., positions and orientations) of each object on the build platform. Alternatively, the first digital representation can depict the geometries of the individual objects without providing the layout of the objects on the build platform.

At block 904, the method 900 can include generating a second digital representation of a plurality of support structures coupled to the object(s). The second digital representation includes one or more 3D models (e.g., surface model, mesh model, parametric model) representing the 3D geometry of the support structures. The support structures can be any of the embodiments described herein. For example, some or all of the support structures can include an exposed region that is accessible to an energy beam of a trimming system, e.g., as previously described in connection with FIGS. 4A and 4B, 5, and 6A-6H. The exposed region can be a curved, angled, or horizontal shoulder of the support structure that extends laterally away from the coupled object, such that the energy beam can reach and cut through the exposed region without passing through the object and/or any other objects on the build platform. The exposed region can be positioned partially or entirely outside of the footprint of the object.

In some embodiments, at least some of the support structures are internal support structures that are coupled to an internal portion of the object, e.g., as previously described in connection with FIGS. 7A-7C. An internal support structure may not include any exposed regions that are directly accessible to the energy beam, e.g., the entirety of the internal support structure may be located within the footprint of the object. In some embodiments, the internal support structure is not intended to be trimmed by the energy beam, while in other embodiments, the internal support structure may be trimmed by the energy beam (e.g., if the energy beam also cuts through a portion of the object, as discussed elsewhere herein).

In some embodiments, at least some of the support structures are support structures that extend vertically below the object, e.g., similar to the support structures 306 of FIG. 3. In some embodiments, at least some of the support structures are interconnected support structures that couple to a plurality of objects, e.g., as previously described in connection with FIGS. 8A-8C.

In some embodiments, the process of block 904 involves analyzing the geometries of the object(s) of the first digital representation to determine locations and geometries for the plurality of support structures. For instance, the analysis can involve identifying one or more locations in each object that should be supported during additive manufacturing (“support locations”), such as overhangs, bridges, islands, valleys, and/or other components that would deform or collapse without support. A support structure can then be generated for each support location, with the geometry of the support structure being determined based on some or all of the following considerations: whether there are other components proximate to the support locations that could obstruct an energy beam (e.g., another portion of the object, other objects, and/or other support structures), whether the support location is at an internal or external portion of the object, locations of other objects relative to the object, layout of objects on the build platform, locations of energy source(s) relative to the object, movement range of the energy source(s), angular range of the energy beam(s) produced by the energy source(s), movement range of the build platform, type of material used to form the support structure, targeted cutting time for the support structure, and/or permissible angles for the energy beam to cut through the support structure (e.g., to avoid sharp edges).

The geometry of the support structure can be configured to comply with one or more constraints, such as some or all of the following: minimum and/or maximum height, minimum and/or maximum length (e.g., total length and/or horizontal length), minimum and/or maximum thickness, minimum and/or maximum curvature, minimum and/or maximum angle, minimum and/or maximum size of the exposed region (e.g., at least x % of the total length of the support structure is accessible to the trimming system), minimum and/or maximum distance between the exposed region and the first end portion that is connected to the object, minimum and/or maximum distance between the exposed region and the closest surface of the object (e.g., the exposed region must extend at least x mm away from the closet lateral surface of the object), minimum and/or maximum distance between the support structure and other components on the build platform (e.g., other support structures and/or other objects), and/or printability constraints (e.g., minimum feature size, maximum overhang distance, maximum overhang angle).

In some embodiments, the geometry of the support structure is customized to the particular layout of objects on the build platform and/or the particular configuration of the trimming system, such that the support structure includes an exposed region that will be accessible to the trimming system. Optionally, certain support structures can be designed without exposed regions (e.g., if the support structure is an internal support structure and/or is not intended to be removed by the trimming system). A representative example of a method for generating support structures that may be used in the process of block 904 is described below in connection with FIG. 10.

At block 906, the method 900 can include generating instructions for fabricating the object(s) with the support structures via the additive manufacturing process. The instructions can be based on the first and second digital representations of blocks 902 and 904, and can be any digital data set configured to control an additive manufacturing system to fabricate the object(s) with the support structures, in accordance with any of the additive manufacturing techniques described herein (e.g., SLA or DLP). For example, the instructions can include a 3D digital model of the object(s) with the support structures that are produced by combining the first and second digital representations (e.g., a CAD file, STL file, OBJ file, AMF file, 3MF file), a plurality of 2D cross-sections (e.g., slices) generated from the 3D digital model (e.g., a BMP file or PNG file), and/or a tool path file generated from the 3D digital model and/or 2D cross-sections (e.g., a G-code file). The instructions can depict the geometries of the object(s) and support structure to be fabricated, as well as the layout (e.g., position and orientations) of the object(s) on the build platform. The instructions can be transmitted to an additive manufacturing system to cause the additive manufacturing system to fabricate the object(s) with the support structures.

The method 900 can be modified in many different ways. For example, the method 900 can be used to generate support structures for any suitable number of objects, such as tens, hundreds, or thousands of objects. In some embodiments, the objects are associated with a single individual (e.g., a series of dental appliances used to treat a single patient), while in other embodiments, the objects can be associated with multiple individuals (e.g., a batch of dental appliances for a plurality of patients). As another example, the ordering of the processes shown in FIG. 9 can be varied. Some of the processes of the method 900 can be omitted, and/or the method 900 can also include additional processes not shown in FIG. 9.

FIG. 10 is a flow diagram illustrating a method 1000 for generating support structures for additively manufactured objects, in accordance with embodiments of the present technology. The method 1000 can be used to design any of the support structures described herein. In some embodiments, some or all of the processes of the method 1000 are implemented as computer-readable instructions (e.g., program code) that are configured to be executed by one or more processors of a computing device, such as a computing device of an appliance design system. The method 1000 can be combined with any of the other methods described herein, such as the method 900 of FIG. 9. For instance, some or all of the processes of the method 1000 can be performed as part of the process of block 904 of FIG. 9.

The method 1000 can begin at block 1002 with generating a geometry for a plurality of support structures coupled to one or more objects. The geometry can be or include any of the support structure geometries described herein, e.g., in connection with FIGS. 4A and 4B, 5, 6A-6H, 7A-7C, and 8A-8C. For instance, the geometry can include any of the dimensional parameters discussed above in connection with FIG. 4B. The generated geometry can be provided as a digital representation (e.g., a 3D model) of the support structures together with the corresponding objects.

In some embodiments, the geometry of each support structure is determined based on some or all of the following considerations: whether there are other components proximate to the support locations that could obstruct an energy beam (e.g., another portion of the object, other objects, and/or other support structures), whether the support location is at an internal or external portion of the object, locations of other objects relative to the object, layout of objects on the build platform, locations of energy source(s) relative to the object, movement range of the energy source(s), angular range of the energy beam(s) produced by the energy source(s), movement range of the build platform, type of material used to form the support structure, targeted cutting time for the support structure, and/or permissible angles for the energy beam to cut through the support structure (e.g., to avoid sharp edges).

In some embodiments, the geometry of each support structure is determined based on some or all of the following constraints: minimum and/or maximum height, minimum and/or maximum length (e.g., total length and/or horizontal length), minimum and/or maximum thickness, minimum and/or maximum curvature, minimum and/or maximum angle, minimum and/or maximum size of the exposed region (e.g., at least x % of the total length of the support structure is accessible to the trimming system), minimum and/or maximum distance between the exposed region and the first end portion that is connected to the object, minimum and/or maximum distance between the exposed region and the closest surface of the object (e.g., the exposed region must extend at least x mm away from the closet lateral surface of the object), minimum and/or maximum distance between the support structure and other components on the build platform (e.g., other support structures and/or other objects), and/or printability constraints (e.g., minimum feature size, maximum overhang distance, maximum overhang angle).

At block 1004, the method 1000 can include determining whether at least some of the support structures are accessible to a trimming system (e.g., the system 400 of FIG. 4A). The process of block 1004 can include, for example, identifying whether there is an unobstructed path for an energy beam of the trimming system to reach and cut through at least a portion of the support structure. Stated differently, the process of block 1004 can include evaluating whether the support structure includes an exposed region that is accessible to an energy beam of the trimming system. The identification can be performed in various ways. For instance, simulations, modeling, mathematical calculations, etc., can be performed to determine whether each support structure is accessible, e.g., based on the configuration of the trimming system (e.g., locations of the energy source(s), movement range of the energy source(s), angular range of the energy beam(s) produced by the energy source(s), movement range of the build platform), the layout of objects on the build platform, and the geometries of the support structures generated in block 1002.

In some embodiments, the process of block 1004 involves determining whether all of the support structures are accessible to the trimming system. Alternatively, the process of block 1004 can involve determining whether only some of the support structures are accessible to the trimming system, e.g., if certain support structures are not intended to be trimmed by the trimming system, and/or if it is permissible to cut through portions of an object to reach certain support structures (e.g., internal support structures).

Based on the determination of block 1004, the method 1000 can proceed to block 1006 with modifying at least one support structure. For example, if it is determined that one or more support structures are not accessible to the trimming system, the method 1000 can include modifying at least one support structure to improve accessibility. The modification can include changing a location of a support structure, changing a geometry of a support structure (e.g., changing the shape and/or dimensions of the support structure), removing a support structure, adding a support structure, changing a spacing between a support structure and another component (e.g., another support structure or an object), or suitable combinations thereof. In some embodiments, modifications are made only to support structures that are determined to be inaccessible, while in other embodiments, modifications can be made to other support structures (e.g., support structures that block access to another support structure).

Alternatively or in combination, based on the determination of block 1004, the method 1000 can proceed to block 1006 with modifying a layout of at least one object. For example, if it is determined that one or more support structures are not accessible to the trimming system, the method 1000 can include modifying a layout of at least one object to improve accessibility. The modification can include changing a position of the object on the build platform, changing an orientation of the object on the build platform, changing a spacing between the object and another component on the build platform (e.g., another object or a support structure), removing an object from the build platform, adding an object to the build platform, or suitable combinations thereof. In some embodiments, modifications are made only to objects having a support structure that is determined to be inaccessible, while in other embodiments, modifications can be made to other objects (e.g., objects that block access to a support structure).

The processes of blocks 1006 and 1008 can be performed sequentially (e.g., the process of block 1006 may be performed before or after the process of block 1008) or concurrently. Optionally, the process of block 1006 may be performed without performing the process of block 1008, such that the support structures are modified without modifying the object layout; or the process of block 1008 may be performed without performing the process of block 1006, such that the object layout is modified without modifying the support structures.

After modifications have been made according to the processes of blocks 1006 and/or 1008, the method 1000 can return to block 1004 to determine whether the modifications have rendered some or all of the support structures accessible to the trimming system. If some support structures are still inaccessible, the processes of blocks 1006 and/or 1008 can be repeated to make further modifications to improve accessibility. Accordingly, the processes of blocks 1004, 1006, and/or 1008 can be iterated until a satisfactory configuration of objects and support structures is achieved (e.g., all support structures that are intended to be cut by the trimming system are accessible. Optionally, other factors besides accessibility can also be considered, such as increasing the packing density of objects on the build platform, maintaining printability of the objects and support structures, reducing trimming, reducing complexity of the trimming path, reducing the amount of material used to print the support structures, etc.

The method 1000 can subsequently proceed to block 1010 with generating instructions for fabricating the object(s) with the support structures via an additive manufacturing process. The instructions can be any digital data set configured to control an additive manufacturing system to fabricate the object(s) with the support structures, in accordance with any of the additive manufacturing techniques described herein (e.g., SLA or DLP). For example, the instructions can include a 3D digital model of the object(s) with the support structures (e.g., a CAD file, STL file, OBJ file, AMF file, 3MF file), a plurality of 2D cross-sections (e.g., slices) generated from the 3D digital model (e.g., a BMP file or PNG file), and/or a tool path file generated from the 3D digital model and/or 2D cross-sections (e.g., a G-code file). The instructions can depict the geometries of the object(s) and support structure to be fabricated, as well as the layout of the object(s) on the build platform. The instructions can be transmitted to an additive manufacturing system to cause the additive manufacturing system to fabricate the object(s) with the support structures.

The method 1000 can be modified in many different ways. For example, the method 1000 can be used to generate support structures for any suitable number of objects, such as tens, hundreds, or thousands of objects. In some embodiments, the objects are associated with a single individual (e.g., a series of dental appliances used to treat a single patient), while in other embodiments, the objects can be associated with multiple individuals (e.g., a batch of dental appliances for a plurality of patients). As another example, the ordering of the processes shown in FIG. 10 can be varied. Some of the processes of the method 1000 can be omitted (e.g., the process of block 1006 or block 1008), and/or the method 1000 can also include additional processes not shown in FIG. 10.

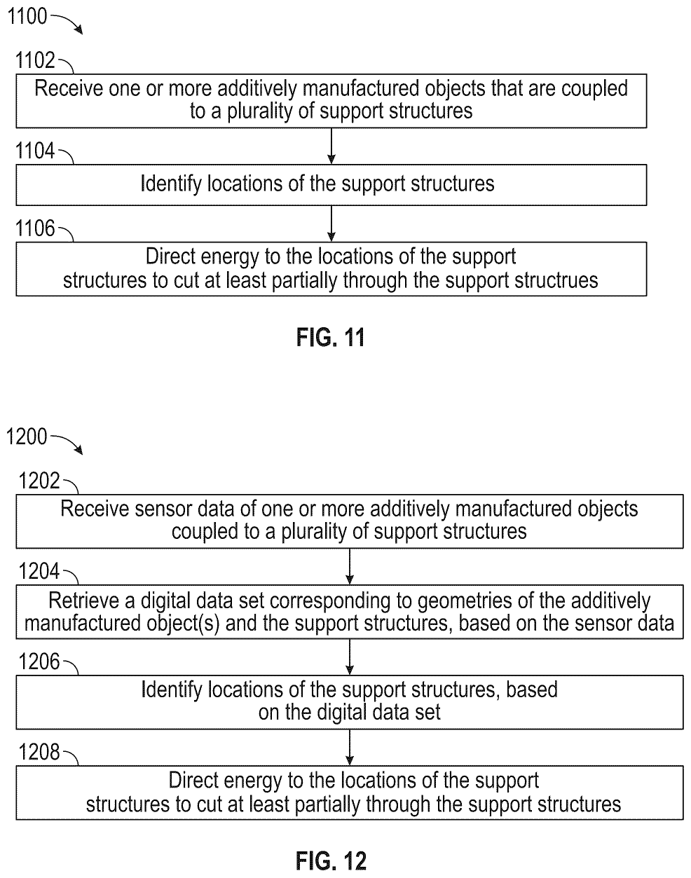

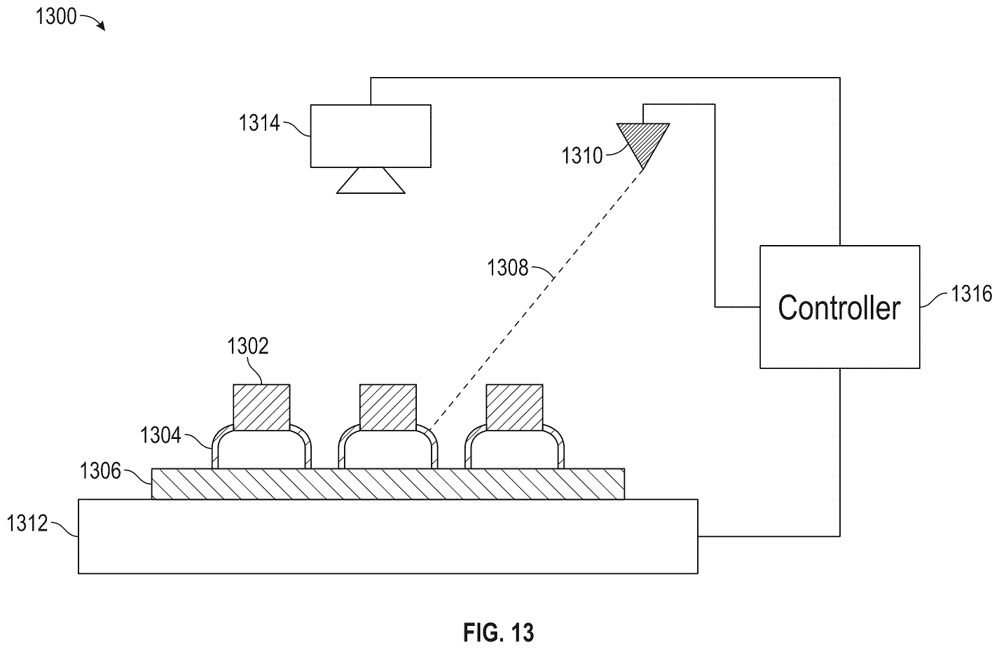

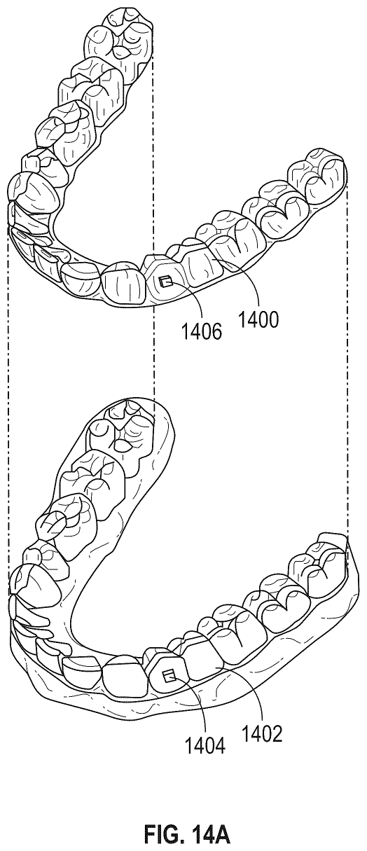

FIG. 11 is a flow diagram illustrating a method 1100 for trimming support structures from additively manufactured objects, in accordance with embodiments of the present technology. The method 1100 can be used to trim any of the additively manufactured objects with support structures described herein. In some embodiments, some or all of the processes of the method 1100 are implemented as computer-readable instructions (e.g., program code) that are configured to be executed by one or more processors of a computing device, such as a controller of a trimming system (e.g., the system 400 of FIG. 4 and/or the system 1300 of FIG. 13 described below). The method 1100 can be combined with any of the other methods described herein, such as the method 100 of FIG. 1. For instance, some or all of the processes of the method 1100 can be performed as part of the process of block 108 of FIG. 1.

The method 1100 can begin at block 1102 with receiving one or more additively manufactured objects that are coupled to a plurality of support structures. For example, the object(s) can include one or more dental appliances (e.g., aligners, palatal expanders, attachment placement devices, retainers) that are fabricated via any of the additive manufacturing processes described herein (e.g., SLA, DLP). Each object can be connected to a build platform via a respective set of one or more support structures, which can be any of the embodiments described herein. For example, some or all of the support structures of an object can include an exposed region that is accessible to an energy beam of a trimming system, e.g., as previously described in connection with FIGS. 4A and 4B, 5, and 6A-6H. Alternatively or in combination, at least some of the support structures are internal support structures that are coupled to an internal portion of the object, e.g., as previously described in connection with FIGS. 7A-7C. Alternatively or in combination, at least some of the support structures are support structures that extend vertically below the object, e.g., similar to the support structures 306 of FIG. 3. Alternatively or in combination, at least some of the support structures are interconnected support structures that couple to a plurality of objects, e.g., as previously described in connection with FIGS. 8A-8C.

At block 1104, the method 1100 can include identifying locations of at least some of the support structures. The locations can include portions of the support structures that are intended to be cut by a trimming system. For instance, the locations can include exposed regions of one or more support structures that extend laterally away from the coupled object and are thus accessible to an energy beam of the trimming system. The exposed regions can be curved, angled, or horizontal shoulders of the support structures that are located outside of the footprint of the object, and are not shadowed by other objects on the build platform, as described elsewhere herein. Alternatively or in combination, the locations can include portions of one or more support structures that are not exposed but are nevertheless intended to be cut by the trimming system. For instance, the locations can include a portion of an internal support structure that is connected to an internal portion of the object. In such embodiments, the internal support structure can be cut by directing energy through the object and to the connection between the internal support structure and the object, as described elsewhere herein.

The identification of the locations of the support structures can be performed in various ways, such as based on sensor data (e.g., image data; data from RFID tags, barcode, or other identifiers), based on a digital data set of the object(s) and support structures (e.g., a layout file), based on input from an operator, or suitable combinations thereof. A representative example of a method for identifying locations of support structures that may be used in the process of block 1104 is described below in connection with FIG. 12.

At block 1106, the method 1100 can continue with directing energy to the locations of the support structures to cut at least partially through the support structures. For instance, the trimming system can include an energy source (e.g., a laser source) that outputs an energy beam (e.g., a laser beam) that ablates, burns, melts, or otherwise degrades the material of the support structure to cut partially or entirely through the support structure. Optionally, multiple energy sources can be used to produce multiple energy beams for targeting the support structures, with each energy beam being targeted to a respective subset of support structures to selectively cut those support structures. Alternatively or in combination, the trimming system can use other types of energy, such as thermal energy, acoustic energy (e.g., ultrasound), mechanical energy (e.g., application of pressurized fluids), etc.

In some embodiments, the energy is targeted to exposed regions of one or more support structures to selectively cut the exposed regions without cutting other portions of the support structures and/or other objects. Optionally, certain portions of the object may be cut together with the exposed region, such as a portion of the object adjacent to the exposed region. Moreover, in some embodiments, the energy can be targeted to one or more support structures that do not include exposed regions but are nevertheless intended to be cut. For instance, the energy can be targeted to and cut through a portion of an object in order to reach and cut through an internal support structure within the object.

The targeting of the energy can be accomplished in various ways, such as by moving the energy beam, moving the energy source, and/or moving the build platform with the objects. In some embodiments, the energy beam is moved through a sequence of locations according to a predetermined trimming path, thereby sequentially cutting through the support structures of the object(s). The trimming path can be determined based on the layout of the object(s) and support structures, and may be optimized to reduce cutting time, reduce the risk of damage to nontarget structures, and/or reduce the risk of the object(s) collapsing or otherwise moving during the trimming process (e.g., certain support structures such as internal support structures may be cut last or may not be cut at all in order to stabilize the object(s)).

In embodiments where the build platform is also movable (e.g., due to being placed on or within a movable trimming platform), the movement of the build platform can be coordinated with the movement of the energy beam along the trimming path to ensure that the support structures are cut at the correct location and in the proper sequence. For instance, the build platform can be moved along a movement path as the energy beam is moved along the trimming path. The movement path can be determined based on the trimming path as well as the layout of the object(s) and support structures, and may be optimized to reduce cutting time and to reduce the risk of damage to nontarget structures.

The process of block 1106 can be performed to trim some or all of the support structures from the object(s). After the trimming process, further post-processing of the object(s) can be performed, such as washing, polishing, packaging, etc. In some embodiment, if certain support structures were not trimmed in the process of block 1106, these support structures can be removed in a subsequent trimming process (e.g., manual removal).

The method 1100 can be modified in many different ways. For example, the method 1100 can be used to trim support structures from any suitable number of additively manufactured objects, such as tens or hundreds of objects. In some embodiments, the objects are associated with a single individual (e.g., a series of dental appliances used to treat a single patient), while in other embodiments, the objects can be associated with multiple individuals (e.g., a batch of dental appliances for a plurality of patients). As another example, the ordering of the processes shown in FIG. 11 can be varied. Some of the processes of the method 1100 can be omitted, and/or the method 1100 can also include additional processes not shown in FIG. 11.

FIG. 12 is a flow diagram illustrating a method 1200 for trimming support structures from additively manufactured objects, in accordance with embodiments of the present technology. The method 1200 can be used to trim any of the additively manufactured objects with support structures described herein. In some embodiments, some or all of the processes of the method 1200 are implemented as computer-readable instructions (e.g., program code) that are configured to be executed by one or more processors of a computing device, such as a controller of a trimming system (e.g., the system 400 of FIG. 4 and/or the system 1300 of FIG. 13 described below). The method 1200 can be combined with any of the other methods described herein, such as the method 1100 of FIG. 11. For instance, some or all of the processes of the method 1200 can be performed as part of the process of block 1104 of FIG. 11.

The method 1200 can begin at block 1202 with receiving sensor data of one or more additively manufactured objects coupled to a plurality of support structures. For example, the object(s) can include one or more dental appliances (e.g., aligners, palatal expanders, attachment placement devices, retainers) that are fabricated via any of the additive manufacturing processes described herein (e.g., SLA, DLP). Each object can be connected to a build platform via a respective set of one or more support structures, which can be any of the embodiments described herein. For example, some or all of the support structures of an object can include an exposed region that is accessible to an energy beam of a trimming system, e.g., as previously described in connection with FIGS. 4A and 4B, 5, and 6A-6H. Alternatively or in combination, at least some of the support structures are internal support structures that are coupled to an internal portion of the object, e.g., as previously described in connection with FIGS. 7A-7C. Alternatively or in combination, at least some of the support structures are support structures that extend vertically below the object, e.g., similar to the support structures 306 of FIG. 3. Alternatively or in combination, at least some of the support structures are interconnected support structures that couple to a plurality of objects, e.g., as previously described in connection with FIGS. 8A-8C.

The sensor data can be any data type that can be analyzed to identify the object(s), and, optionally, identify the locations of the support structures relative to the object(s). For example, the sensor data can be image data (e.g., photographs, videos) generated by an imaging device, such as a camera or scanner. The image data can depict the geometries of the object(s), as well as their layout (e.g., position, orientation) on the build platform. Optionally, the image data can depict other components on the build platform, such as the geometries and locations of the support structures, and/or at least one identifier on the build platform, such as a barcode, QR code, label, tag, fiducial marker, etc. The identifier(s) can correspond to one or more objects on the build platform (e.g., a unique identifier for each object), can correspond to the entire batch of objects on the build platform (e.g., a batch identifier), and/or can be used to identify a position and/or orientation of the build platform relative to the trimming system (e.g., fiducial markers that serve as a reference for targeting the trimming system). In some embodiments, the identifier(s) are printed on the build platform together with the objects to provide a reference for identification of the objects.

As another example, the sensor data can be data of a machine-readable tag (“tag data”), such as an RFID tag, barcode, QR code, etc. The tag can be integrally formed with or coupled to an object, or can be located on the build platform (e.g., proximate to a corresponding object). In such embodiments, the sensor data can be generated by a tag reader, such as an RFID reader, barcode scanner, QR code scanner, etc. The tag data can include at least one identifier, which can correspond to one or more objects on the build platform (e.g., a unique identifier for each object) and/or can correspond to the entire batch of objects on the build platform (e.g., a batch identifier).

For instance, FIG. 13 is a partially schematic illustration of a system 1300 for trimming additively manufactured objects 1302, in accordance with embodiments of the present technology. The system 1300 can be used to perform any of the methods herein, including the method 1200 of FIG. 12. The system 1300 includes a plurality of additively manufactured objects 1302 with support structures 1304 on a build platform 1306. The objects 1302 and support structures 1304 can include any of the features of the various embodiments described herein (e.g., with respect to FIGS. 4A and 4B, 5, 6A-6H, 7A-7C, and 8A-8C). Although FIG. 13 illustrates three objects 1302 each including two support structures 1304, the techniques herein can be applied to any suitable number of objects 1302 on the same build platform 1306 (e.g., one, two, four, five, 10, 20, 50, or more objects 1302), and each object 1302 can independently include any suitable number of support structures 1304, (e.g., five, 10, 20, 30, 40, 50, or more support structures 1304).

As shown in FIG. 13, the system 1300 includes at least one sensor 1314 configured to obtain sensor data of the objects 1302. Although the sensor 1314 is depicted as an imaging device (e.g., a camera), in other embodiments, the sensor 1314 can be a different sensor type, such as a tag reader. Moreover, FIG. 13 illustrates a single sensor 1314, in other embodiments, the system 1300 can include multiple sensors 1314, such as two, three, four, five, 10, 20, or more sensors 1314. In embodiments where multiple sensors 1314 are used, some or all of the sensors 1314 can be different sensor types, and/or some or all of the sensors 1314 can be positioned at different locations relative to the objects 1302 and build platform 1306.

In the illustrated embodiment, the sensor 1314 is positioned above the objects 1302 and the build platform 1306 in order to generate sensor data (e.g., image data) of the objects 1302, support structures 1304, and/or build platform 1306. In other embodiments, however, the sensor 1314 can be positioned at a different location relative to the objects 1302 and build platform 1306, such as to a lateral side of the objects 1302 and build platform 1306. Optionally, the sensor 1314 can be coupled to an actuator (e.g., a motor, gimbal, robotic arm) to move the sensor 1314 to different positions and/or orientations relative to the objects 1302 and build platform 1306, e.g., in one, two, or three degrees of freedom in translation, and/or one, two, or three degrees of freedom in rotation. In other embodiments, however, the sensor 1314 can be stationary (e.g., at a fixed position and orientation relative to the objects 1302 and build platform 1306).

The sensor 1314 can be configured so that the field of view of the sensor 1314 covers all of the objects 1302 and/or the entire build platform 1306. Alternatively, the sensor 1314 can be configured so that the field of view covers only some of the objects 1302 and/or only a portion of the build platform 1306 (e.g., a portion of the build platform 1306 including an identifier such as a tag). In such embodiments, the sensor 1314 can be movable to a plurality of different positions and/or orientation relative to the objects 1302 and build platform 1306 in order to generate sensor data of all of the objects 1302 and/or the entire build platform 1306. Alternatively or in combination, multiple sensors 1314 can be used to collectively generate sensor data of all of the objects 1302 and/or the entire build platform 1306, with each sensor 1314 having a respective field of view that covers a respective subset of the objects 1302 and/or a respective portion of the build platform 1306. The sensor(s) 1314 can be operably coupled to a controller 1316, which can be a computing device configured to process and analyze the sensor data to identify the locations of the support structures 1304 of the objects 1302, as discussed further below.

Referring again to FIG. 12, at block 1204, the method 1200 can continue with retrieving a digital data set corresponding to geometries of the additively manufactured object(s) and the support structures, based on the sensor data. The digital data set can include one or more digital representations of the of the object(s) and support structures, such as one or more 3D models (e.g., surface models, mesh models, parametric models) representing the 3D geometries of the object(s) and support structures. In some embodiments, the digital data set is or is based on the instructions used for fabricating the objects with the support structures. For instance, the digital data set can be a digital file (e.g., a CAD file, STL file, OBJ file, AMF file, 3MF file) that depict the geometries of the object(s) and support structure to be fabricated, as well as the layout (e.g., position and orientations) of the object(s) on the build platform. Alternatively or in combination, the digital data set can be a digital file (e.g., a tool path file such as a G-code file) representing a predetermined trimming path that indicates a sequence of locations for trimming the support structures. Optionally, the digital file can also include a coordinate reference for the trimming path, such as a set of coordinates representing the origin (0, 0, 0) of the reference frame for the trimming path. The digital data set can be generated using any of the methods described herein, such as the method 900 of FIG. 9 and/or the method 1000 of FIG. 10.

In some embodiments, the digital data set is retrieved based on an identifier associated with the object(s). For instance, the sensor data received in block 1202 can be used to determine an identifier for each of the object(s) and/or an identifier for the entire batch of object(s), as discussed above. The identifier(s) can then be used to retrieve the appropriate digital data set from a datastore (e.g., a database that is accessible to the controller of the trimming system). In embodiments where the sensor data includes image data of an identifier (e.g., a barcode, QR code, label, tag), the identifier can be extracted from the image data using computer vision techniques, machine learning algorithms, and/or other suitable image analysis techniques known to those of skill in the art. The extracted identifier can then be used to identify and retrieve a digital data set associated with a matching identifier. Alternatively or in combination, in embodiments where the object(s) have a unique geometry (e.g., a geometry customized to a particular patient and/or a particular treatment stage), the object geometry can serve as an identifier. For example, the contours of the objects can be extracted from the image data using computer vision techniques, machine learning algorithms, and/or or other suitable image analysis techniques known to those of skill in the art. The extracted contours can then be used to identify and retrieve a digital data set having objects with the same or similar contours.

At block 1206, the method 1200 can include identifying locations of at least some of the support structures, based on the digital data set. The locations can include portions of the support structures that are intended to be cut by a trimming system. For instance, the locations can include exposed regions of one or more support structures that extend laterally away from the coupled object and are thus accessible to an energy beam of the trimming system. The exposed regions can be curved, angled, or horizontal shoulders of the support structures that are located outside of the footprint of the object, and are not shadowed by other objects on the build platform, as described elsewhere herein. Alternatively or in combination, the locations can include portions of one or more support structures that are not exposed but are nevertheless intended to be cut by the trimming system. For instance, the locations can include a portion of an internal support structure that is connected to an internal portion of the object. In such embodiments, the internal support structure can be cut by directing energy through the object and to the connection between the internal support structure and the object, as described elsewhere herein.

The locations can be identified based on the digital data set of block 1204. For example, in embodiments where the digital data set includes one or more 3D models of the object(s) and support structures, certain portions of the support structures can be tagged or otherwise labeled with an indication that the support structures should be trimmed at those portions. For instance, the digital data set can include a set of coordinate locations (e.g., pixel or voxel coordinates) corresponding to the exposed regions of the support structures that are accessible for trimming, and/or to portions of internal support structures that are intended to be trimmed. Alternatively or in combination, the digital data set can include a predetermined trimming path that indicates a sequence of locations for trimming the support structures. Optionally, in some embodiments, the locations can be identified directly from the sensor data, rather than based on the digital data set. For example, in embodiments where the sensor data includes image data of the object(s) and support structures, the locations of the support structures can be identified from the image data using computer vision techniques, machine learning algorithms, etc.

At block 1208, the method 1200 can include directing energy to the locations of the support structures to cut at least partially through the support structures. As described herein, the energy can be produced by an energy beam that is targeted to the locations of exposed regions of one or more support structures to selectively cut the exposed regions without cutting other portions of the support structures and/or other objects. Optionally, certain portions of the object may be cut together with the exposed region, such as a portion of the object adjacent to the exposed region. Moreover, in some embodiments, the energy can be targeted to one or more support structures that do not include exposed regions but are nevertheless intended to be cut. For instance, the energy can be targeted to and cut through a portion of an object in order to reach and cut through an internal support structure within the object.

For instance, referring again to FIG. 13, the system 1300 can include an energy source 1310 (e.g., a laser source) that outputs an energy beam 1308 (e.g., a laser beam) that ablates, burns, melts, or otherwise degrades the material of the support structures 1304 to cut partially or entirely through the support structures 1304. The features and operation of the energy beam 1308 and energy source 1310 can be identical or generally similar to the corresponding components of the system 400 of FIG. 4. For example, the energy beam 1308 can be positioned above the build platform 1306 and objects 1302 to reach some or all of the support structures 1304 from a vertical or nearly vertical location above the objects 1302. In some embodiments, the energy beam 1308 is movable relative to the objects 1302 and build platform 1306, e.g., the energy source 1310 can sweep the energy beam 1308 through a plurality of different angles. Alternatively or in combination, the energy source 1310 itself can be movable relative to the objects 1302 and build platform 1306. Alternatively or in combination, the build platform 1306 is movable relative to the energy source 1310, e.g., via placement on or within a trimming platform 1312 that is movable in one, two, or three degrees of freedom in translation; and/or one, two, or three degrees of freedom in rotation.

The energy beam 1308 can be targeted to the support structures 1304 in various ways, such as by moving the energy beam 1308, moving the energy source 1310, and/or moving the build platform 1306 with the objects 1302. In some embodiments, the controller 1316 moves the energy beam 1308 to each of the identified locations according to a trimming path, thereby sequentially cutting through the support structures 1304 of the objects 1302. The trimming path can be determined by the controller 1316 (e.g., based on the locations identified in block 1206 of FIG. 12), or can be predetermined trimming path that is transmitted to the controller 1316. In embodiments where the build platform 1306 is also movable (e.g., due to being placed on or within a movable trimming platform 1312), the controller 1316 can also coordinate the movement of the build platform 1306 with the movement of the energy beam 1308 along the trimming path to ensure that the support structures 1304 are cut at the correct location and in the proper sequence. For instance, the build platform 1306 can be moved along a movement path as the energy beam 1308 is moved along the trimming path. The movement path can be determined by the controller 1316 (e.g., based on the trimming path) or can be a predetermined movement path that is transmitted to the controller 1316.

Optionally, as the energy beam 1308 moves along the trimming path, additional sensor data from the sensor 1314 (e.g., image data) can be used to provide feedback to controller 1316. For instance, the sensor data can indicate whether the support structures 1304 have been correctly trimmed, whether additional passes are needed to completely cut through a support structure 1304, whether the energy beam 1308 is moving correctly along the trimming path, whether the build platform 1306 is moving correctly along the movement path, whether inadvertent damage to nontargeted components has occurred, whether any of the objects 1302 have collapsed or otherwise moved during trimming, etc. In such embodiments, the controller 1316 can adjust the operation of the energy source 1310 and/or trimming platform 1312 based on the feedback. For instance, if the sensor data indicates that a support structure 1304 was missed or was not completely cut, the controller 1316 can direct the energy beam 1308 back to the support structure 1304 to attempt to cut the support structure 1304. Optionally, the controller 1316 can generate alerts, notifications, etc., to an operator, e.g., if manual intervention is needed.

Although FIG. 13 illustrates a single energy source 1310, in other embodiments, the system 300 can include a plurality of energy sources 1310 (e.g., two, three, four, five, or more energy sources 1310) that output a plurality of respective energy beams 1308 (e.g., two, three, four, five, or more energy beams 1308) toward the objects 1302. In such embodiments, each energy source 1310 can be positioned at a different respective location relative to the build platform 1306 and the objects 1302. Each energy source 1310 can independently move its respective energy beam 1308 relative to the objects 1302 and build platform 1306, and/or can be independently movable relative to the objects 1302 and build platform 1306.

Referring again to FIG. 12, the process of block 1208 can be performed to trim some or all of the support structures from the object(s). After the trimming process, further post-processing of the object(s) can be performed, such as washing, polishing, packaging, etc. In some embodiment, if certain support structures were not trimmed in the process of block 1208, these support structures can be removed in a subsequent trimming process (e.g., manual removal).

The method 1200 can be modified in many different ways. For example, the method 1200 can be used to trim support structures from any suitable number of additively manufactured objects, such as tens or hundreds of objects. In some embodiments, the objects are associated with a single individual (e.g., a series of dental appliances used to treat a single patient), while in other embodiments, the objects can be associated with multiple individuals (e.g., a batch of dental appliances for a plurality of patients). As another example, the ordering of the processes shown in FIG. 12 can be varied. Some of the processes of the method 1200 can be omitted (e.g., the process of block 1204), and/or the method 1200 can also include additional processes not shown in FIG. 12. Moreover, although the method 1200 is described in connection with the components of the system 1300 of FIG. 13, the method 1200 can be performed using other trimming systems, and the system 1300 can be used to perform other methods for trimming support structures.

### II. Dental Appliances and Associated Methods

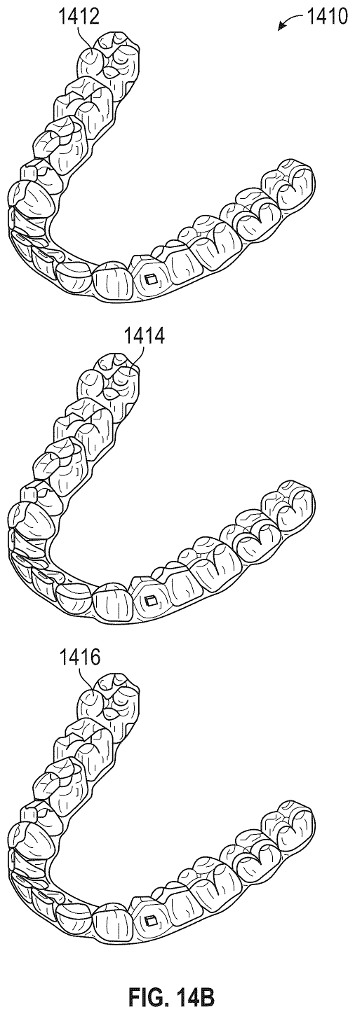

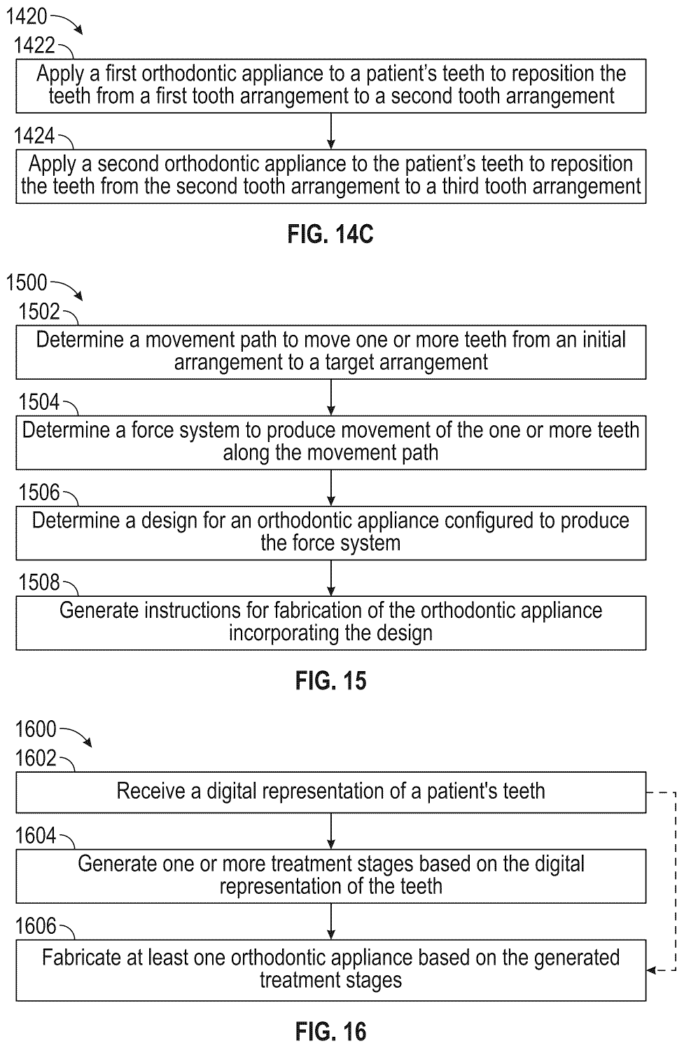

FIG. 14A illustrates a representative example of a tooth repositioning appliance 1400 configured in accordance with embodiments of the present technology. The appliance 1400 can be manufactured using any of the systems, methods, and devices described herein. The appliance 1400 (also referred to herein as an “aligner”) can be worn by a patient in order to achieve an incremental repositioning of individual teeth 1402 in the jaw. The appliance 1400 can include a shell (e.g., a continuous polymeric shell or a segmented shell) having teeth-receiving cavities that receive and resiliently reposition the teeth. The appliance 1400 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1400 can fit over all teeth present in an upper or lower jaw, or less than all of the teeth. The appliance 1400 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1400 can be a generic appliance configured to receive the teeth, but not necessarily shaped to match the topography of the patient's teeth. In some cases, only certain teeth received by the appliance 1400 are repositioned by the appliance 1400 while other teeth can provide a base or anchor region for holding the appliance 1400 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1400 in place over the teeth. In some cases, however, it may be desirable or necessary to provide individual attachments 1404 or other anchoring elements on teeth 1402 with corresponding receptacles 1406 or apertures in the appliance 1400 so that the appliance 1400 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 14B illustrates a tooth repositioning system 1410 including a plurality of appliances 1412, 1414, 1416, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1410 can include a first appliance 1412 corresponding to an initial tooth arrangement, one or more intermediate appliances 1414 corresponding to one or more intermediate arrangements, and a final appliance 1416 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 14C illustrates a method 1420 of orthodontic treatment using a plurality of appliances, in accordance with embodiments of the present technology. The method 1420 can be practiced using any of the appliances or appliance sets described herein. In block 1422, a first orthodontic appliance is applied to a patient's teeth in order to reposition the teeth from a first tooth arrangement to a second tooth arrangement. In block 1424, a second orthodontic appliance is applied to the patient's teeth in order to reposition the teeth from the second tooth arrangement to a third tooth arrangement. The method 1420 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 15 illustrates a method 1500 for designing an orthodontic appliance, in accordance with embodiments of the present technology. The method 1500 can be applied to any embodiment of the orthodontic appliances described herein. Some or all of the steps of the method 1500 can be performed by any suitable data processing system or device, e.g., one or more processors configured with suitable instructions.

In block 1502, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1504, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1504 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1506, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systemes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1508, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1500 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1500 may be performed with any suitable fabrication system or device, such as the embodiments described herein. Some of the steps may be optional, e.g., the process of block 1504 can be omitted, such that the orthodontic appliance is designed based on the desired tooth movements and/or determined tooth movement path, rather than based on a force system. Moreover, the order of the steps can be varied as desired.

FIG. 16 illustrates a method 1600 for digitally planning an orthodontic treatment and/or design or fabrication of an appliance, in accordance with embodiments. The method 1600 can be applied to any of the treatment procedures described herein and can be performed by any suitable data processing system.

In block 1602, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1604, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1606, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 16, design and/or fabrication of an orthodontic appliance, and perhaps a particular orthodontic treatment, may include use of a representation of the patient's teeth (e.g., including receiving a digital representation of the patient's teeth (block 1602)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

Example 1. A method comprising:
receiving one or more additively manufactured objects that are coupled to a plurality of support structures, wherein each support structure comprises an exposed shoulder region that is accessible to an energy beam of a trimming system;
identifying locations of the exposed shoulder regions of the plurality of support structures; and
directing the energy beam of the trimming system to the locations of the exposed shoulder regions of the plurality of support structures to cut at least partially through the exposed shoulder regions of the plurality of support structures.

Example 2. The method of Example 1, wherein at least one support structure of the plurality of support structures comprises a first end portion coupled to an additively manufactured object and a second end portion coupled to a build platform, and the exposed shoulder region of the at least one support structure is located at or proximate to the first end portion.

Example 3. The method of Example 2, wherein the first end portion of the at least one support structure is coupled to a lateral surface of the additively manufactured object.

Example 4. The method of Example 2 or 3, wherein the exposed shoulder region of the at least one support structure is located outside a footprint of the additively manufactured object.

Example 5. The method of any one of Examples 2 to 4, wherein the exposed shoulder region of the at least one support structure extends laterally away from the additively manufactured object.

Example 6. The method of any one of Examples 2 to 5, wherein the exposed shoulder region of the at least one support structure is curved or angled away from the additively manufactured object.

Example 7. The method of any one of Examples 1 to 6, wherein the energy beam is directed to the locations of the exposed shoulder regions without passing through any of the additively manufactured objects.

Example 8. The method of any one of Examples 1 to 7, wherein the energy beam cuts entirely through the exposed shoulder region of least one support structure.

Example 9. The method of any one of Examples 1 to 8, wherein the energy beam cuts only partially through the exposed shoulder region of at least one support structure.

Example 10. The method of any one of Examples 1 to 9, wherein at least one additively manufactured object of the one or more additively manufactured objects is further coupled to at least one additional support structure that is coupled to an internal portion of the at least one additively manufactured object.

Example 11. The method of Example 10, further comprising directing the energy beam to cut through a portion of the at least one additively manufactured object to reach the at least one additional support structure.

Example 12. The method of any one of Examples 1 to 11, wherein at least one additively manufactured object of the one or more additively manufactured objects is further coupled to at least one additional support structure that is not cut by the energy beam.

Example 13. The method of Example 12, wherein the at least one additional support structure is coupled to an internal portion of the at least one additively manufactured object.

Example 14. The method of any one of Examples 1 to 13, further comprising moving the one or more additively manufactured objects relative to the energy beam.

Example 15. The method of any one of Examples 1 to 14, further comprising moving the energy beam relative to the one or more additively manufactured objects.

Example 16. The method of any one of Examples 1 to 15, wherein the energy beam is a laser beam.

Example 17. The method of any one of Examples 1 to 16, further comprising receiving sensor data of the one or more additively manufactured objects, wherein the locations of the exposed shoulder regions are identified based on the sensor data.

Example 18. The method of Example 17, wherein the sensor data comprises image data of the one or more additively manufactured objects.

Example 19. The method of Example 17 or 18, wherein the sensor data comprises data of an identifier on or proximate to the one or more additively manufactured objects.

Example 20. The method of any one of Examples 17 to 19, further comprising retrieving a digital data set corresponding to geometries of the one or more additively manufactured objects and the plurality of support structures, based on the sensor data.

Example 21. The method of Example 20, wherein the digital data set comprises a predetermined trimming path including the locations of the exposed shoulder regions.

Example 22. The method of Example 20 or 21, wherein the locations of the exposed shoulder regions are identified based on the digital data set.

Example 23. The method of any one of Examples 20 to 22, wherein the digital data set comprises 3D digital models of the one or more additively manufactured objects and the plurality of support structures.

Example 24. The method of any one of Examples 1 to 23, wherein the one or more additively manufactured objects comprise one or more dental appliances.

Example 25. The method of any one of Examples 1 to 24, wherein the one or more additively manufactured objects and the plurality of support structures comprise a plurality of cured material layers.

Example 26. A system comprising:
a trimming platform configured to receive one or more additively manufactured objects that are coupled to a plurality of support structures;
an energy source configured to output an energy beam;
one or more processors; and
a memory operably coupled to the one or more processors and comprising instructions that, when executed by the one or more processors, cause the system to perform operations comprising:
   identifying a location of an exposed shoulder region of each support structure, wherein the exposed shoulder region is accessible to the energy beam of the energy source, and
   directing the energy beam to the locations of the exposed shoulder regions of the plurality of support structures to cut at least partially through the exposed shoulder regions of the plurality of support structures.

Example 27. The system of Example 26, wherein at least one support structure of the plurality of support structures comprises a first end portion coupled to an additively manufactured object and a second end portion coupled to a build platform, and the exposed shoulder region of the at least one support structure is located at or proximate to the first end portion.

Example 28. The system of Example 27, wherein the first end portion of the at least one support structure is coupled to a lateral surface of the additively manufactured object.

Example 29. The system of Example 27 or 28, wherein the exposed shoulder region of the at least one support structure is located outside a footprint of the additively manufactured object.

Example 30. The system of any one of Examples 27 to 29, wherein the exposed shoulder region of the at least one support structure extends laterally away from the additively manufactured object.

Example 31. The system of any one of Examples 27 to 30, wherein the exposed shoulder region of the at least one support structure is curved or angled away from the additively manufactured object.

Example 32. The system of any one of Examples 26 to 31, wherein the energy beam is directed to the locations of the exposed shoulder regions without passing through any of the additively manufactured objects.

Example 33. The system of any one of Examples 26 to 32, wherein the energy beam is configured to cut entirely through the exposed shoulder region of least one support structure.

Example 34. The system of any one of Examples 26 to 33, wherein the energy beam is configured to cut only partially through the exposed shoulder region of at least one support structure.

Example 35. The system of any one of Examples 26 to 34, wherein at least one additively manufactured object of the one or more additively manufactured objects is further coupled to at least one additional support structure that is coupled to an internal portion of the at least one additively manufactured object.

Example 36. The system of Example 35, wherein the energy beam is configured to cut through a portion of the at least one additively manufactured object to reach the at least one additional support structure.

Example 37. The system of any one of Examples 26 to 36, wherein at least one additively manufactured object of the one or more additively manufactured objects is further coupled to at least one additional support structure that is not cut by the energy beam.

Example 38. The system of Example 37, wherein the at least one additional support structure is coupled to an internal portion of the at least one additively manufactured object.

Example 39. The system of any one of Examples 26 to 38, further comprising an actuator coupled to the trimming platform and configured to move the trimming platform relative to the energy source.

Example 40. The system of any one of Examples 26 to 39, further comprising an actuator coupled to the energy source and configured to move the energy source relative to the trimming platform.

Example 41. The system of any one of Examples 26 to 40, wherein the energy beam is a laser beam.

Example 42. The system of any one of Examples 26 to 41, further comprising a sensor configured to generate sensor data of the one or more additively manufactured objects, wherein the locations of the exposed shoulder regions are identified based on the sensor data.

Example 43. The system of Example 42, wherein the sensor comprises an imaging device.

Example 44. The system of Example 42 or 43, wherein the sensor is configured to read an identifier on or proximate to the one or more additively manufactured objects.

Example 45. The system of any one of Examples 42 to 44, wherein the operations further comprise retrieving a digital data set corresponding to geometries of the one or more additively manufactured objects and the plurality of support structures, based on the sensor data.

Example 46. The system of Example 45, wherein the digital data set comprises a predetermined trimming path including the locations of the exposed shoulder regions.

Example 47. The system of Example 45 or 46, wherein the locations of the exposed shoulder regions are identified based on the digital data set.

Example 48. The system of any one of Examples 45 to 47, wherein the digital data set comprises 3D digital models of the one or more additively manufactured objects and the plurality of support structures.

Example 49. The system of any one of Examples 26 to 48, wherein the one or more additively manufactured objects comprise one or more dental appliances.

Example 50. The system of any one of Examples 26 to 49, wherein the one or more additively manufactured objects and the plurality of support structures comprise a plurality of cured material layers.

Example 51. A method comprising:
receiving a first digital representation of one or more objects to be fabricated via an additive manufacturing process;
generating a second digital representation of a plurality of support structures coupled to the one or more objects, wherein each support structure comprises an exposed shoulder region that configured to be accessible to an energy beam of a trimming system; and
generating instructions for fabricating the one or more objects with the plurality of support structures via the additive manufacturing process based on the first and second digital representations.

Example 52. The method of Example 51, wherein at least one support structure of the plurality of support structures comprises a first end portion coupled to an object and a second end portion configured to be coupled to a build platform, and the exposed shoulder region of the at least one support structure is located at or proximate to the first end portion.

Example 53. The method of Example 52, wherein the first end portion of the at least one support structure is coupled to a lateral surface of the object.

Example 54. The method of Example 52 or 53, wherein the exposed shoulder region of the at least one support structure is located outside a footprint of the object.

Example 55. The method of any one of Examples 52 to 54, wherein the exposed shoulder region of the at least one support structure extends laterally away from the object.

Example 56. The method of any one of Examples 52 to 55, wherein the exposed shoulder region of the at least one support structure is curved or angled away from the object.

Example 57. The method of any one of Examples 51 to 56, wherein the exposed shoulder regions are configured to be at least partially cut by the energy beam of the trimming system.

Example 58. The method of any one of Examples 51 to 57, wherein the plurality of support structures are configured to allow the energy beam to access each of the exposed shoulder regions without passing through any of the objects.

Example 59. The method of any one of Examples 51 to 58, wherein the second digital representation further comprises at least one additional support structure that is coupled to an internal portion of at least one object of the plurality of objects.

Example 60. The method of any one of Examples 51 to 59, wherein generating the second digital representation comprises:
generating an initial geometry for the plurality of support structures, and
determining whether the exposed shoulder regions of the plurality of support structures with the initial geometry are accessible to the energy beam of the trimming system.

Example 61. The method of Example 60, further comprising modifying the initial geometry of at least one support structure based on the determination.

Example 62. The method of Example 61, wherein modifying the initial geometry comprises modifying one or more of a shape, a location, or a dimension of the at least one support structure.

Example 63. The method of any one of Examples 60 to 62, further comprising modifying a layout of at least one object based on the determination.

Example 64. The method of Example 63, wherein modifying the layout comprises modifying one or more of a position or an orientation of the at least one object.

Example 65. The method of any one of Examples 51 to 64, wherein the one or more objects comprise one or more dental appliances.

Example 66. The method of any one of Examples 51 to 65, wherein the additive manufacturing process comprises fabricating the one or more objects and the plurality of objects from a curable material in a layer-by-layer manner.

Example 67. A system comprising:
one or more processors; and
a memory operably coupled to the one or more processors and storing instructions that, when executed by the one or more processors, cause the system to perform operations comprising:
   receiving a first digital representation of one or more objects to be fabricated via an additive manufacturing process,
   generating a second digital representation of a plurality of support structures coupled to the one or more objects, wherein each support structure comprises an exposed shoulder region that configured to be accessible to an energy beam of a trimming system, and
   generating instructions for fabricating the one or more objects with the plurality of support structures via the additive manufacturing process based on the first and second digital representations.

Example 68. The system of Example 67, wherein at least one support structure of the plurality of support structures comprises a first end portion coupled to an object and a second end portion configured to be coupled to a build platform, and the exposed shoulder region of the at least one support structure is located at or proximate to the first end portion.

Example 69. The system of Example 68, wherein the first end portion of the at least one support structure is coupled to a lateral surface of the object.

Example 70. The system of Example 68 or 69, wherein the exposed shoulder region of the at least one support structure is located outside a footprint of the object.

Example 71. The system of any one of Examples 68 to 70, wherein the exposed shoulder region of the at least one support structure extends laterally away from the object.

Example 72. The system of any one of Examples 68 to 71, wherein the exposed shoulder region of the at least one support structure is curved or angled away from the object.

Example 73. The system of any one of Examples 67 to 72, wherein the exposed shoulder regions are configured to be at least partially cut by the energy beam of the trimming system.

Example 74. The system of any one of Examples 67 to 73, wherein the plurality of support structures are configured to allow the energy beam to access each of the exposed shoulder regions without passing through any of the objects.

Example 75. The system of any one of Examples 67 to 74, wherein the second digital representation further comprises at least one additional support structure that is coupled to an internal portion of at least one object of the plurality of objects.

Example 76. The system of any one of Examples 67 to 75, wherein generating the second digital representation comprises:
generating an initial geometry for the plurality of support structures, and
determining whether the exposed shoulder regions of the plurality of support structures with the initial geometry are accessible to the energy beam of the trimming system.

Example 77. The system of Example 76, wherein the operations further comprise modifying the initial geometry of at least one support structure based on the determination.

Example 78. The system of Example 77, wherein modifying the initial geometry comprises modifying one or more of a shape, a location, or a dimension of the at least one support structure.

Example 79. The system of any one of Examples 76 to 78, wherein the operations further comprise modifying a layout of at least one object based on the determination.

Example 80. The system of Example 79, wherein modifying the layout comprises modifying one or more of a position or an orientation of the at least one object.

Example 81. The system of any one of Examples 67 to 80, wherein the one or more objects comprise one or more dental appliances.

Example 82. The system of any one of Examples 67 to 81, wherein the additive manufacturing process comprises fabricating the one or more objects and the plurality of support structures from a curable material in a layer-by-layer manner.

Example 83. The system of any one of Examples 67 to 82, further comprising the trimming system.

Example 84. The system of Example 83, wherein the trimming system comprises an energy source configured to output the energy beam.

Example 85. The system of Example 83 or 84, wherein the trimming system comprises a trimming platform configured to receive one or more objects after fabrication.

Example 86. The system of Example 85, wherein the trimming system comprises an actuator coupled to the trimming platform.

Example 87. A non-transitory computer-readable storage medium comprising instructions that, when executed by one or more processors of a computing system, cause the computing system to perform operations comprising:
receiving a first digital representation of one or more objects to be fabricated via an additive manufacturing process;
generating a second digital representation of a plurality of support structures coupled to the one or more objects, wherein each support structure comprises an exposed shoulder region that configured to be accessible to an energy beam of a trimming system; and
generating instructions for fabricating the one or more objects with the plurality of support structures via the additive manufacturing process based on the first and second digital representations.

Example 88. An additively manufactured object comprising:
a dental appliance configured to receive one or more teeth of a patient; and
a plurality of support structures coupled to the dental appliance, wherein each support structure comprises:
   a first end portion coupled to the dental appliance,
   a second end portion configured to be coupled to a build platform, and
   an exposed shoulder region at or proximate to the first end portion, wherein the exposed shoulder region extends laterally away from the dental appliance and is configured to be accessible to an energy beam of a trimming system.

Example 89. The additively manufactured object of Example 88, wherein the first end portion of at least one support structure is coupled to a lateral surface of the dental appliance.

Example 90. The additively manufactured object of Example 88 or 89, wherein the first end portion of at least one support structure is coupled to a bottom surface of the dental appliance, and the dental appliance further comprises an undercut in the bottom surface proximate to the first end portion of the at least one support structure.

Example 91. The additively manufactured object of any one of Examples 88 to 90, wherein the exposed shoulder region of at least one support structure is located outside a footprint of the dental appliance.

Example 92. The additively manufactured object of any one of Examples 88 to 91, wherein the exposed shoulder region of at least one support structure is curved or angled.

Example 93. The additively manufactured object of any one of Examples 88 to 92, wherein the exposed shoulder region of at least one support structure is horizontal.

Example 94. The additively manufactured object of any one of Examples 88 to 93, wherein the second end portion of at least one support structure is spaced laterally apart from the dental appliance.

Example 95. The additively manufactured object of any one of Examples 88 to 94, wherein the second end portion of at least one support structure is positioned underneath the dental appliance.

Example 96. The additively manufactured object of any one of Examples 88 to 95, wherein the exposed shoulder regions of the plurality of support structures are configured to be at least partially cut by the energy beam.

Example 97. The additively manufactured object of any one of Examples 88 to 96, further comprising at least one additional support structure that is coupled to an internal portion of the dental appliance.

Example 98. The additively manufactured object of any one of Examples 88 to 97, wherein at least one support structure is coupled to a second dental appliance.

Example 99. The additively manufactured object of any one of Examples 88 to 98, wherein the dental appliance is an aligner, a palatal expander, a mouth guard, or an attachment placement device.

Example 100. The additively manufactured object of any one of Examples 88 to 99, wherein the dental appliance comprises an appliance shell having a plurality of cavities configured to receive and reposition the one or more teeth.

Example 101. The additively manufactured object of any one of Examples 88 to 100, wherein the dental appliance and plurality of support structures comprise a plurality of cured material layers.

Example 102. A method comprising:
receiving one or more additively manufactured objects that are coupled to a plurality of support structures, wherein the plurality of support structures includes at least one internal support structure that is coupled to an internal portion of an additively manufactured object;
identifying locations of the plurality of support structures; and
directing an energy beam of a trimming system to the locations of the plurality of support structures to cut at least partially through the plurality of support structures, wherein the energy beam cuts through the additively manufactured object to reach and cut at least partially through the at least one internal support structure.

Example 103. The method of Example 102, wherein the internal portion is an internal surface of the additively manufactured object.

Example 104. The method of Example 103, wherein the additively manufactured object comprises an external surface opposite the internal surface, and the energy beam cuts through the external surface and the internal surface to reach the at least one internal support structure.

Example 105. The method of any one of Examples 102 to 104, wherein the at least one internal support structure comprises a first end portion coupled to the internal portion of the additively manufactured object and a second end portion coupled to a build platform.

Example 106. The method of any one of Examples 102 to 105, wherein the at least one internal support structure is located below the additively manufactured object.

Example 107. The method of any one of Examples 102 to 106, wherein the at least one internal support structure is located entirely within a footprint of the additively manufactured object.

Example 108. The method of any one of Examples 102 to 107, wherein the plurality of support structures include at least one external support structure that is coupled to an external portion of the additively manufactured object.

Example 109. The method of Example 108, wherein the at least one external support structure comprises an exposed shoulder region that is accessible to the energy beam of the trimming system.

Example 110. The method of Example 108 or 109, wherein the at least one external support structure extends vertically below the additively manufactured object.

Example 111. The method of any one of Examples 102 to 110, wherein at least one additively manufactured object of the one or more additively manufactured objects is further coupled to at least one additional support structure that is not cut by the energy beam.

Example 112. The method of any one of Examples 102 to 111, further comprising moving the one or more additively manufactured objects relative to the energy beam.

Example 113. The method of any one of Examples 102 to 112, further comprising moving the energy beam relative to the one or more additively manufactured objects.

Example 114. The method of any one of Examples 102 to 113, wherein the energy beam is a laser beam.

Example 115. The method of any one of Examples 102 to 114, further comprising receiving sensor data of the one or more additively manufactured objects, wherein the locations of the support structures are identified based on the sensor data.

Example 116. The method of Example 115, wherein the sensor data comprises image data of the one or more additively manufactured objects.

Example 117. The method of Example 115 or 116, wherein the sensor data comprises data of an identifier on or proximate to the one or more additively manufactured objects.

Example 118. The method of any one of Examples 115 to 117, further comprising retrieving a digital data set corresponding to geometries of the one or more additively manufactured objects and the plurality of support structures, based on the sensor data.

Example 119. The method of Example 118, wherein the digital data set comprises a predetermined trimming path including the locations of the support structures.

Example 120. The method of Example 118 or 119, wherein the locations of the support structures are identified based on the digital data set.

Example 121. The method of any one of Examples 118 to 120, wherein the digital data set comprises 3D digital models of the one or more additively manufactured objects and the plurality of support structures.

Example 122. The method of any one of Examples 102 to 121, wherein the one or more additively manufactured objects comprise one or more dental appliances.

Example 123. The method of any one of Examples 102 to 122, wherein the one or more additively manufactured objects and the plurality of support structures comprise a plurality of cured material layers.

Example 124. A system comprising:
a trimming platform configured to receive one or more additively manufactured objects that are coupled to a plurality of support structures;
an energy source configured to output an energy beam;
one or more processors; and
a memory operably coupled to the one or more processors and comprising instructions that, when executed by the one or more processors, cause the system to perform operations comprising:
   identifying locations of the plurality of support structures, wherein the plurality of support structures includes at least one internal support structure that is coupled to an internal portion of an additively manufactured object, and
   directing the energy beam to the locations of the plurality of support structures to cut at least partially through the plurality of support structures, wherein the energy beam cuts through the additively manufactured object to reach and cut at least partially through the at least one internal support structure.

Example 125. The system of Example 124, wherein the internal portion is an internal surface of the additively manufactured object.

Example 126. The system of Example 125, wherein the additively manufactured object comprises an external surface opposite the internal surface, and the energy beam cuts through the external surface and the internal surface to reach the at least one internal support structure.

Example 127. The system of any one of Examples 124 to 126, wherein the at least one internal support structure comprises a first end portion coupled to the internal portion of the additively manufactured object and a second end portion coupled to a build platform.

Example 128. The system of any one of Examples 124 to 127, wherein the at least one internal support structure is located below the additively manufactured object.

Example 129. The system of any one of Examples 124 to 128, wherein the at least one internal support structure is located entirely within a footprint of the additively manufactured object.

Example 130. The system of any one of Examples 124 to 129, wherein the plurality of support structures include at least one external support structure that is coupled to an external portion of the additively manufactured object.

Example 131. The system of Example 130, wherein the at least one external support structure comprises an exposed shoulder region that is accessible to the energy beam of the trimming system.

Example 132. The system of Example 130 or 131, wherein the at least one external support structure extends vertically below the additively manufactured object.

Example 133. The system of any one of Examples 124 to 132, wherein at least one additively manufactured object of the one or more additively manufactured objects is further coupled to at least one additional support structure that is not cut by the energy beam.

Example 134. The system of any one of Examples 124 to 133, further comprising an actuator coupled to the trimming platform and configured to move the trimming platform relative to the energy source.

Example 135. The system of any one of Examples 124 to 134, further comprising an actuator coupled to the energy source and configured to move the energy source relative to the trimming platform.

Example 136. The system of any one of Examples 124 to 135, wherein the energy beam is a laser beam.

Example 137. The system of any one of Examples 124 to 136, further comprising a sensor configured to generate sensor data of the one or more additively manufactured objects, wherein the locations of the support structures are identified based on the sensor data.

Example 138. The system of Example 137, wherein the sensor comprises an imaging device.

Example 139. The system of Example 137 or 138, wherein the sensor is configured to read an identifier on or proximate to the one or more additively manufactured objects.

Example 140. The system of any one of Examples 137 to 139, wherein the operations further comprise retrieving a digital data set corresponding to geometries of the one or more additively manufactured objects and the plurality of support structures, based on the sensor data.

Example 141. The system of Example 140, wherein the digital data set comprises a predetermined trimming path including the locations of the support structures.

Example 142. The system of Example 140 or 141, wherein the locations of the support structures are identified based on the digital data set.

Example 143. The system of any one of Examples 140 to 142, wherein the digital data set comprises 3D digital models of the one or more additively manufactured objects and the plurality of support structures.

Example 144. The system of any one of Examples 124 to 143, wherein the one or more additively manufactured objects comprise one or more dental appliances.

Example 145. The system of any one of Examples 124 to 144, wherein the one or more additively manufactured objects and the plurality of support structures comprise a plurality of cured material layers.

### CONCLUSION

Although many of the embodiments are described above with respect to systems, devices, and methods for manufacturing of dental appliances, the technology is applicable to other applications and/or other approaches, such as manufacturing of other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-16.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A system comprising:
a trimming platform configured to receive one or more additively manufactured objects that are coupled to a plurality of support structures;
an energy source configured to output an energy beam;
one or more processors; and
a memory operably coupled to the one or more processors and comprising instructions that, when executed by the one or more processors, cause the system to perform operations comprising:
identifying a location of an exposed shoulder region of each support structure, wherein the exposed shoulder region is accessible to the energy beam of the energy source, and
directing the energy beam to the locations of the exposed shoulder regions of the plurality of support structures to cut at least partially through the exposed shoulder regions of the plurality of support structures.

2. The system of claim 1, wherein at least one support structure of the plurality of support structures comprises a first end portion coupled to an additively manufactured object and a second end portion coupled to a build platform, and the exposed shoulder region of the at least one support structure is located at or proximate to the first end portion.

3. The system of claim 2, wherein the exposed shoulder region of the at least one support structure is located outside a footprint of the additively manufactured object.

4. The system of claim 2, wherein the exposed shoulder region of the at least one support structure extends laterally away from the additively manufactured object.

5. The system of claim 2, wherein the exposed shoulder region of the at least one support structure is curved or angled away from the additively manufactured object.

6. The system of claim 1, wherein the energy beam is directed to the locations of the exposed shoulder regions without passing through any of the additively manufactured objects.

7. The system of claim 1, wherein the energy beam is configured to cut entirely through the exposed shoulder region of least one support structure.

8. The system of claim 1, wherein the energy beam is configured to cut only partially through the exposed shoulder region of at least one support structure.

9. The system of claim 1, wherein at least one additively manufactured object of the one or more additively manufactured objects is further coupled to at least one additional support structure that is coupled to an internal portion of the at least one additively manufactured object.

10. The system of claim 9, wherein the energy beam is configured to cut through a portion of the at least one additively manufactured object to reach the at least one additional support structure.

11. The system of claim 1, further comprising an actuator coupled to the trimming platform and configured to move the trimming platform relative to the energy source.

12. The system of claim 1, further comprising an actuator coupled to the energy source and configured to move the energy source relative to the trimming platform.

13. The system of claim 1, wherein the energy beam is a laser beam.

14. The system of claim 1, further comprising a sensor configured to generate sensor data of the one or more additively manufactured objects, wherein the locations of the exposed shoulder regions are identified based on the sensor data.

15. The system of claim 14, wherein the sensor comprises an imaging device.

16. The system of claim 14, wherein the sensor is configured to read an identifier on or proximate to the one or more additively manufactured objects.

17. The system of claim 14, wherein the operations further comprise retrieving a digital data set corresponding to geometries of the one or more additively manufactured objects and the plurality of support structures, based on the sensor data.

18. The system of claim 17, wherein the digital data set comprises a predetermined trimming path including the locations of the exposed shoulder regions.

19. The system of claim 1, wherein the one or more additively manufactured objects comprise one or more dental appliances.

20. The system of claim 1, wherein the one or more additively manufactured objects and the plurality of support structures comprise a plurality of cured material layers.
